(19) United States
(12) Patent Application Publication
(10) Pub. No.: US 2008/0192343 A1
(43) Pub. Date: Aug. 14, 2008

(54) THREE-DIMENSIONAL IMAGE DISPLAY APPARATUS

(75) Inventors: Tetsuyuki Miyawaki, Kanagawa (JP); Kyohei Iwamoto, Tokyo (JP); Yoshio Suzuki, Kanagawa (JP); Xueming Yu, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/026,601

(22) Filed: Feb. 6, 2008

(30) Foreign Application Priority Data
Feb. 9, 2007 (JP) 2007-030567
Jun. 27, 2007 (JP) 2007-169408

(51) Int. Cl. G02B 27/22

(52) U.S. Cl. 359/462

(57) ABSTRACT

Disclosed herein is a three-dimensional image display apparatus, including: a light source configured to emit light from a plurality of light emitting positions disposed discretely; optical modulation means for including a plurality of pixels and configured such that a plurality of light beams successively emitted from the different light emitting positions of the light source and having different incoming directions from each other are modulated individually by the pixels to generate two-dimensional images and spatial frequencies of the generated two-dimensional images are individually emitted along diffraction angles corresponding to a plurality of diffraction orders generated from the pixels; and Fourier transform image forming means for Fourier transforming the spatial frequencies of the two-dimensional images emitted from the optical modulation means to produce a number of Fourier transform images corresponding to the plural number of diffraction orders to form the Fourier transform images.

### CROSS REFERENCES TO RELATED APPLICATIONS

The present invention contains subject matter related to Japanese Patent Application JP 2007-169408 filed with the Japan Patent Office on Jun. 27, 2007, the entire contents of which being incorporated herein by reference.

### BACKGROUND OF THE INVENTION

1. Field of the Invention

This invention relates to a three-dimensional image display apparatus which can display a stereoscopic image.

2. Description of the Related Art

In the past, a two-eye type stereoscopic image technique wherein both eyes of an observer observe images different from each other called parallax images to obtain a stereoscopic effect and a multi-eye type stereoscopic image technique wherein a plurality of sets of parallax images are prepared to obtain a plurality of stereoscopic images from different viewpoints are known in the past, and various techniques relating to such techniques have been and are being developed very much. However, according to the two-eye type stereoscopic image technique or the multi-eye type stereoscopic image technique, a stereoscopic image is positioned in an intended space as a stereoscopic image, but exists, for example, on a two-dimensional display plane and exists at a fixed position. Accordingly, particularly convergence and adjustment which are physiologic reactions of the ophthalmencephalon do not interlink with each other, and visual fatigue caused by this makes a problem.

Meanwhile, in the real world, information of the surface of a physical solid propagates to the eyeballs of the observer through a light wave serving as a medium. As a technique by which a light wave from the surface of a physical solid in the real world can be physically reproduced artificially, a holography technique is available. In a stereoscopic image which uses a holography technique, interference fringes generated by interference of light are used, and a diffracted light wave front itself which is generated when light is illuminated on the interference fringes is used as an image information medium. Therefore, an image with which such physiologic reactions of the optical system as convergence and adjustment similar to those when the observer observes a physical solid in the real world occurs and the visual fatigue is reduced can be provided. Further, that the light wave front from the physical solid is reproduced signifies that the continuity is assured in a direction in which image information is transmitted. Accordingly, even if the viewpoint of the observer moves, it is possible to successively present an appropriate image from the different angle according to the movement, and motion parallaxes are provided successively.

However, according to the holography technique, three-dimensional spatial information of a physical solid is recorded as interference fringes in a two-dimensional space, and the amount of information is very great when compared with that of information of a two-dimensional space on a picked up photograph of the same physical solid or the like. It is considered that this arises from the fact that, when information of a three-dimensional space is converted into information of a two-dimensional space, the information is converted into density in the two-dimensional space. Therefore, the spatial resolution necessary for a display device which displays interference fringes by CGH (Computer Generated Hologram) is very high, and a very great amount of information may be required. Therefore, in the existing condition, it is technically difficult to implement a stereoscopic image based on a real time hologram.

In the holography technique, light waves which can be regarded as continuous information are used as an information medium to transmit information from a physical solid. Meanwhile, as a technique of discretizing light waves and using light beams to reproduce a situation theoretically substantially equivalent to a field formed from light waves in the real world to produce a stereoscopic image, a light beam reproduction method or integral photography method is known. In the light beam reproduction technique, a light beam group composed of a large number of light beams propagating in many directions is scattered into a space by optical means in advance. Then, those light beams which are to be propagated from a virtual physical solid surface disposed at an arbitrary position are selected from the light beam group, and modulation of the intensity or phase of the selected light beams is carried out to generate an image formed from the light beams in the space. An observer can observe the image as a stereoscopic image. The stereoscopic image by the light beam reproduction method is formed at an arbitrary point from multiple images from a plurality of directions and can be observed in a different manner depending upon the position from which the stereoscopic image is observed similarly as in the case wherein a three-dimensional physical solid in the real world is observed.

As an apparatus for implementing the light beam reproduction described above, an apparatus has been proposed which utilizes a combination of a flat display apparatus such as a liquid crystal display apparatus or a plasma display apparatus and a microlens array or a pin-hole array. An apparatus of the type described is disclosed, for example, in Japanese Patent Laid-Open Nos. 2003-173128, 2003-161912, 2003-295114, 2003-75771, 2002-72135 and 2001-56450 and Japanese Patent No. 3,523,605. Also an apparatus has been proposed which includes a large number of projector units juxtaposed with each other. FIG. 26 shows an example of a configuration of a three-dimensional display apparatus which implements a light beam reproduction method using projector units. Referring to FIG. 26, the apparatus shown includes a large number of projector units 101 disposed in a juxtaposed relationship in a horizontal direction and a vertical direction. Light beams are emitted at different angles from each of the projector units 101. With the apparatus, images of multiple visual angles are multiple reproduced at an arbitrary point in a certain sectional plane 102 thereby to implement a stereoscopic image.

### SUMMARY OF THE INVENTION

According to the light beam reproduction method, since images are generated from light beams of an intensity with which they act effectively upon focal adjustment and binocular convergence angle adjustment as visual sensation functions, which have been impossible with two-eye and multi-eye type stereoscopic images, a stereoscopic image which provides very little fatigue to an observer can be provided. Besides, since light beams are continuously emitted in a plurality of directions from the same element on a virtual physical solid, the variation of the image upon movement of the viewpoint position can be provided continuously.

However, the image generated by the light beam reproduction technique at present lacks in provision of a sense of reality when compared with a physical solid in the real world. It is considered that this arises from the fact that the stereoscopic image by the light beam reproduction technique at present is generated from a much smaller amount of information, that is, from a much smaller amount of light beams, than the amount of information which the observer obtains from the physical solid in the real world. Generally, it is considered that the limit to visual observation of a human being is approximately a minute in angular resolution, and a stereoscopic image by the light beam reproduction method at present is produced from an amount of light beams insufficient to the visual sensation. Accordingly, in order to generate a stereoscopic image which provides such a high sense of reality or such reality as is provided by a physical solid in the real world, it is regarded as a subject at least to generate an image from a large amount of light beams.

In order to implement this, a technique may be required first which can generate a light beam group in a spatially high density. It is regarded as one of resolutions to raise the display density of a display apparatus such as a liquid crystal display apparatus. On the other hand, in such an apparatus as shown in FIG. 26 wherein a large number of projector units 101 are disposed, it is a possible idea to miniaturize the projector units 101 such that they are juxtaposed in a spatially high density. However, tremendous enhancement of the display density of display apparatus at present is difficult from the problem of the light utilization efficiency or the diffraction limit. In the case of the apparatus of FIG. 26, since there is a limit to miniaturization of the projector units 101, it is considered difficult to juxtapose the projector units 101 in a spatially high density. In any case, in order to generate a high density light beam group, a plurality of devices may be required, and increase in size of the entire apparatus may not be avoided.

Further, for example, where a light source is formed from light emitting elements, if a dispersion in luminance occurs with the light emitting elements, then an image produced suffers from irregular luminance. As occasion demands, a variation occurs with the color tone of the image and makes a cause of quality deterioration of the image. The dispersion in luminance of the light emitting elements not only occurs upon attachment or assembly of the light source to the three-dimensional image display apparatus, but also occurs depending upon a secular change or a variation in operation environment.

Therefore, it is a desire to provide a three-dimensional image display apparatus which can generate and scatter a group of light beams necessary for display of a stereoscopic image in a spatially high density without increasing the overall size of the apparatus and can provide a stereoscopic image formed from light beams having quality proximate to that of a physical solid in the real world. Also it is a desire to provide a three-dimensional image display apparatus wherein the quality of an image to be displayed is not deteriorated even where a variation occurs with the intensity of light emitted from a light source.

According to a first embodiment of the present invention, there is provided a three-dimensional image display apparatus, including:

a light source configured to emit light from a plurality of light emitting positions disposed discretely;

optical modulation means for including a plurality of pixels and configured such that a plurality of light beams successively emitted from the different light emitting positions of the light source and having different incoming directions from each other are modulated individually by the pixels to generate two-dimensional images and spatial frequencies of the generated two-dimensional images are individually emitted along diffraction angles corresponding to a plurality of diffraction orders generated from the pixels; and

Fourier transform image forming means for Fourier transforming the spatial frequencies of the two-dimensional images emitted from the optical modulation means to produce a number of Fourier transform images corresponding to the plural number of diffraction orders to form the Fourier transform images.

Preferably, the three-dimensional image display apparatus further includes:

conjugate image forming means for forming a conjugate image of any of the Fourier transform images formed by the Fourier transform image forming means.

According to a second embodiment of the present invention, there is provided a three-dimensional image display apparatus, including:

a light source configured to emit light from a plurality of light emitting positions disposed discretely;

a two-dimensional image forming apparatus having a plurality of apertures arrayed in a two-dimensional matrix along an X direction and a Y direction and configured to control, for each of the apertures, passage or reflection of each of light beams successively emitted from the different light emitting positions of the light source and having different incoming directions from each other to produce two-dimensional images and generate, for each of the apertures, a plurality of diffraction light beams of different diffraction orders based on the two-dimensional images;

a first lens having a front side focal plane on which the two-dimensional image forming apparatus is disposed;

a second lens having a front side focal plane on which a rear side focal plane of the first lens is positioned; and

a third lens having a front side focal plane on which a rear side focal plane of the second lens is positioned.

In the three-dimensional image display apparatus according to the first embodiment of the present invention including the preferred form described above or according to the second embodiment of the present invention (the three-dimensional image display apparatus according to the first and second embodiments may sometimes be hereinafter referred to collectively as three-dimensional image display apparatus of the present invention), where the number of discretely disposed light emitting positions is represented by LEP_{Total}, the number of Fourier transform images formed from light beams individually emitted from the light emitting positions and having different incoming directions to the optical modulation means or the two-dimensional image forming apparatus (such light beams may sometimes be hereinafter referred to as illuminating light beams) is given by the (number of diffraction orders×LEP_{Total}). The Fourier transform images based on the illuminating light beams are formed as a spot at discrete positions corresponding to the light emitting positions by the Fourier transform image forming means or the first lens. It is to be noted that, if Fourier transform image selection means or a spatial filter is disposed, then the number of Fourier transform images formed from the illuminating light beams finally becomes, for example, LEP_{Total}. It is to be noted that, where the plural light emitting positions disposed discretely are disposed discretely or in a spaced relationship from each other in a two-dimensional matrix, the number of such light emitting positions is represented by U₀×V₀. Here, U₀×V₀=LEP_{Total}.

The three-dimensional image display apparatus may be configured such that the light source includes a plurality of light emitting elements arrayed in a two-dimensional matrix. It is to be noted that, in this instance, if the number of the light emitting elements arrayed in a two-dimensional matrix is U₀′×V₀′, then the values of U₀′×V₀′ may be U₀′=U₀′ and V₀′=V₀ or, for example, U₀′/3=U₀ and V₀′/3=V₀ depending upon the specifications of the light source. In this instance, preferably the three-dimensional image display apparatus further includes a lens such as, for example, a collimator lens interposed between the light source and the optical modulation means or the two-dimensional image forming apparatus such that the light source is positioned on or in the proximity of a front side focal plane of the lens. This is because the light or illuminating light emitted from the lens is converted into parallel light or substantially parallel light. Or, the three-dimensional image display apparatus may be configured such that the light source includes a light emitting element and light beam advancing direction changing means for changing the incoming direction of light emitted from the light emitting element and directed to be introduced to the optical modulation means. In this instance, the light beam advancing direction changing means may be refraction type optical means which can vary or change the incoming direction of the light beams to be emitted with respect to the incoming light beams such as, for example, a lens, more particularly a collimator lens or a microlens array. Or, the light beam advancing direction changing means may be reflection type optical means which can vary or change the position and the angle of the light beams to be emitted with respect to the incoming light beams such as, for example, a mirror, more particularly a polygon mirror, a combination of a polygon mirror and a mirror, a convex mirror having a curved face, a concave mirror having a curved face, a convex mirror formed from a polygon or a concave mirror formed from a polygon.

Where the light source includes a plurality of light emitting elements arrayed in a two-dimensional matrix as described above, preferably the light emitting elements are disposed so that the emitting directions of light beams to be emitted from the light emitting elements are different from each other and the incoming directions of the light beams to the optical modulation means or the two-dimensional image forming apparatus are different from each other. Further, where refraction type optical means is adopted as the light beam advancing direction changing means, preferably the light source includes a plurality of light emitting elements arrayed in a two-dimensional matrix. In this instance, since the emitting direction of the light beams successively emitted from the light emitting elements and coming to the refractive type optical section when the light beams go out from the refractive type optical section can be changed by the refractive type optical section, the incoming direction of the light beams when they are introduced into the optical modulation means or the two-dimensional image forming apparatus can be changed. It is to be noted that the outgoing directions of the light beams to be emitted individually from the light emitting elements may be same as each other or different from each other. On the other hand, where reflection type optical means is adopted as the light beam advancing direction changing means as described above, the number of light emitting elements may be one or, for example, U₀. Then, the number of the light emitting positions at which the light beams are to be emitted from the reflection light optical means may be set to U₀×V₀=LEP_{Total} by controlling the position or the like of the reflection type optical means. In particular, for example, the inclination angle of an axis of rotation of a polygon mirror is controlled while the polygon mirror is rotated around the axis of rotation. Or, the position of the light beams to be introduced to the mirror from the light emitting elements may be controlled. Or else, the state of the illuminating light to be emitted from the mirror, for example, passage or interception of the illuminating light, may be controlled. The incoming direction of the light beams to be introduced to the optical modulation means or the two-dimensional image forming apparatus can be changed thereby.

The three-dimensional image display apparatus according to the first embodiment of the present invention including the preferred configurations and forms described above may be configured such that the Fourier transform image forming means includes a lens or first lens having a front side focal plane on which the optical modulation means is disposed.

In the three-dimensional image display apparatus according to the first embodiment of the present invention, while images produced and formed by the Fourier transform image forming means correspond to a plurality of diffraction orders, an image obtained based on comparatively low order diffraction is comparatively bright and an image obtained based on comparatively high order diffraction is comparatively dark. Therefore, a stereoscopic image of sufficiently high picture quality can be obtained. However, in order to achieve higher picture quality, preferably the three-dimensional image display apparatus further includes:

Fourier transform image selection means disposed at a position at which the Fourier transform images are formed and for selecting, from among the number of Fourier transform images corresponding to the plural number of diffraction orders generated by the Fourier transform image forming means, a Fourier transform image which corresponds to a desired one of the diffraction orders.

Also in the three-dimensional image display apparatus according to the second embodiment of the present invention, while images produced and formed by the first lens correspond to a plurality of diffraction orders, an image obtained based on comparatively low order diffraction is comparatively bright and an image obtained based on comparatively high order diffraction is comparatively dark. Therefore, a stereoscopic image of sufficiently high picture quality can be obtained. However, in order to achieve higher picture quality, preferably the three-dimensional image display apparatus further includes:

a spatial filter having a number of apertures corresponding to the number of the light emitting positions and capable of being controlled to open and close, the spatial filter being positioned on the rear side focal plane of the first lens.

In this instance, preferably the three-dimensional image display apparatus is configured such that the spatial filter makes a desired one of the apertures into an open state in synchronism with a generation timing of a two-dimensional image by the two-dimensional image forming apparatus. Or, preferably the three-dimensional image display apparatus further includes:

a scattering diffraction restriction member having a number of apertures corresponding to the number of the light emitting positions and positioned on the rear side focal plane of the first lens.

Where the spatial filter or the scattering diffraction restriction member is disposed, only a desired one or ones of the produced diffraction light beams of the diffraction orders can be passed through the same.

In those instances, the Fourier transform image selection means or the spatial filter has a number of apertures corresponding to the number of the light emitting positions, that is, LEP_{Total} equal to, for example, U₀×V₀. Each of the apertures may be controllable between on and off states or may normally be in an open state. The Fourier transform image selection means or the spatial filter which has apertures which can be controlled between open and closed states may be a liquid crystal display apparatus, particularly a liquid crystal display apparatus of the transmission type or the reflection type or a MEMS of the two-dimensional type wherein movable mirrors are arrayed in a two-dimensional matrix. The Fourier transform image selection means or the spatial filter which has apertures which can be controlled between open and closed states may be configured such that it makes a desired one of the apertures into an open state in synchronism with a generation timing of a two-dimensional image by the optical modulation means or the two-dimensional image forming apparatus to select one of the Fourier transform images or the diffraction light beams which corresponds to the desired diffraction order. The position of each aperture may be the position at which a desired Fourier transform image or a desired diffraction light beam from among the Fourier transform images or the diffraction light beams obtained by the Fourier transform image selection means or the first lens, and such positions of the apertures correspond to the light emitting positions disposed discretely.

Preferably, the three-dimensional image display apparatus according to the first embodiment of the present invention including the preferred forms and configurations described above further includes inverse Fourier transform means for inversing Fourier transform any of the Fourier transform images formed by the Fourier transform image forming means to form a real image of the two-dimensional image formed by the optical modulation means.

Further, the three-dimensional image display apparatus according to the first embodiment of the present invention including the preferred forms and configurations described above may be configured such that the optical modulation means includes a two-dimensional spatial optical modulator having a plurality of pixels (P×Q) arrayed two-dimensionally, each of the pixels having an aperture. In this instance, preferably the two-dimensional spatial optical modulator is formed from a liquid crystal display apparatus, more particularly a liquid crystal display apparatus of the transmission type or the reflection type, or is configured such that a movable mirror is provided in each aperture of the two-dimensional spatial optical modulator, that is, it is formed from a two-dimensional type MEMS wherein movable mirrors are arrayed in a two-dimensional matrix. Further, in the three-dimensional image display apparatus according to the second embodiment including the preferred configurations and forms described above, the two-dimensional image forming apparatus may be formed such that it is formed from a liquid crystal display apparatus, more particularly a liquid crystal display apparatus of the transmission type or the reflection type, having a plurality of, that is, P×Q, pixels arrayed two-dimensionally and each having an aperture. Or, the two-dimensional image forming apparatus may otherwise be formed such that it has a plurality of, that is, P×Q, apertures and a movable mirror is provided in each of the apertures, that is, it is formed from a two-dimensional type MEMS wherein a movable mirror is disposed in each of apertures arrayed in a two-dimensional matrix. Here, preferably the apertures have a rectangular planar shape. Where the rectangular planar shape is adopted for the apertures, Fraunhofer diffraction occurs to produce M×N diffraction light beams. In particular, the amplitude or intensity of the incident light wave is periodically modulated by the apertures, and amplitude gratings from which a light amount distribution conforming to the light transmission factor distribution of gratings can be obtained are formed.

Further, the three-dimensional image display apparatus according to the first embodiment of the present invention including the preferred forms and configurations described above may be configured such that the spatial frequencies of the two-dimensional images correspond to image information whose carrier frequency is the spatial frequency of the pixel structure. Further, the three-dimensional image display apparatus may be configured such that the spatial frequencies of a conjugate image of a two-dimensional image hereinafter described are spatial frequencies obtained by removing the spatial frequency of the pixel structure from the spatial frequencies of the two-dimensional image. In particular, those spatial frequencies, obtained as the 1st order diffraction where the 0th order diffraction of plane wave component is a carrier frequency, lower than one half the spatial frequency of the pixel structure or aperture structure of the optical modulation means are selected by the Fourier transform image selection means or the spatial filter, or those spatial frequencies which pass through the Fourier transform image selection means or the spatial filter and are displayed on the optical modulation means or the two-dimensional image forming apparatus are all transmitted.

Preferably, the three-dimensional image display apparatus according to the present embodiment including the preferred forms and configurations described above further includes light detection means for measuring the light intensity of the light beams successively emitted from the different light emitting positions of the light source. Then, the light emitting state of the light source may be controlled or an operation state of the optical modulation means or the two-dimensional image forming apparatus may be controlled, based on a result of the measurement of the light intensity by the light detection means.

The light detection means may be a photodiode, a CCD or a CMOS sensor. A beam splitter or a partially reflecting mirror or partial reflector may be interposed between the light source and the optical modulation means or the two-dimensional image forming apparatus so that part of light which is emitted from the light source and directed to the optical modulation means or the two-dimensional image forming apparatus is extracted and introduced to the light detection means. Or, a partially reflecting mirror may be disposed rearwardly of the Fourier transform image forming means or the two-dimensional image forming apparatus so that part of light emitted from the Fourier transform image forming means or the two-dimensional image forming apparatus is extracted and introduced to the light detection means. Or else, the light detection means may be attached to the optical modulation means or the two-dimensional image forming apparatus, or the light detection means may be incorporated in the light source such that particularly it is disposed, for example, in the proximity of each of the light emitting elements which form the light source or is incorporated in each of the light emitting elements. Or otherwise, the light detection means may be disposed at any position at which it does not intercept light which passes through an effective region from the light source to the optical modulation means or two-dimensional image forming apparatus, the Fourier transform image forming means or a succeeding component.

In the three-dimensional image display apparatus according of the present embodiment including the preferred forms and configurations described above, as regards the numbers of U₀ and V₀, the number of U₀ may be 4≦U₀≦12, preferably, for example, 9≦U₀≦11 though not restricted to them. Meanwhile, the number of V₀ may be 4≦V₀≦12, preferably, for example, 9≦V₀≦11. The value of U₀ and the value of V₀ may be equal to or different from each other. It is to be noted that a plane, that is, an XY plane, on which Fourier transform images are formed by the Fourier transform image forming means is hereinafter referred to sometimes as image forming plane.

In a preferred form of the three-dimensional image display apparatus of the present embodiment, a Fourier transform image corresponding to a desired diffraction order is selected by the Fourier transform image selection means or the spatial filter or passes through the Fourier transform image selection means or the spatial filter. Here, the desired diffraction order may be the 0th diffraction order although it is not limited to this order.

The light source in the three-dimensional image display apparatus according the present embodiment including the various preferred forms and configurations described above may be a laser, a light emitting diode (LED) or a white light source. An illuminating optical system for shaping illuminating light may be disposed between the light source and the optical modulation means or the two-dimensional image forming apparatus. Depending upon the specification of the three-dimensional image display apparatus, single color light such as, for example, light from a red light emitting diode, a green light emitting diode or a blue light emitting diode or white light such as, for example, light from a white light emitting diode may be emitted from the light source. Or the light source may include a red light emitting element, a green light emitting element and a blue light emitting element such that light which is red light, green light or blue light is emitted from the light source by successively driving the light emitting elements. Also by this, illuminating light beams which are emitted from the plural light emitting positions disposed discretely and have different incoming directions to the optical modulation means or the two-dimensional image forming apparatus can be obtained.

In a liquid crystal display apparatus which forms the two-dimensional spatial optical modulator or the two-dimensional image forming apparatus, for example, a region within which a transparent first electrode and a transparent second electrode described below overlap with each other and which includes a liquid cell corresponds to one pixel. Then, the liquid crystal cell is caused to operate as a kind of a light shatter or light valve, that is, the light transmission factor or numerical aperture of each pixel is controlled, to control the light transmission factor of the illuminating light emitted from the light source thereby to obtain a two-dimensional image as a whole. A rectangular aperture is provided in the overlapping region of the transparent first and second electrodes, and as the illuminating light emitted from the light source passes through each aperture, Fraunhofer diffraction occurs with each pixel. Consequently, totaling M×N sets of diffraction light beams are generated.

A liquid crystal display apparatus typically includes a front panel having a transparent first electrode provided thereon, a rear panel having a transparent second electrode provided thereon, and liquid crystal material disposed between the front and rear panels. The front panel particularly includes a first substrate formed typically from a glass substrate or a silicon substrate, a transparent first electrode made of, for example, ITO and provided on an inner face of the first substrate, and a polarizing film provided on an outer face of the first substrate. The transparent first electrode is called also common electrode. Further, an orientation film is provided on the transparent first electrode. Meanwhile, the rear panel particularly includes a second substrate formed typically from a glass substrate or a silicon substrate, a switching element formed on an inner face of the second substrate, a transparent second electrode made of, for example, ITO and controlled between a conducting state and a non-conducting state by the switching element, and a polarizing film provided on an outer face of the second substrate. The transparent second electrode is called also pixel electrode. An orientation film is formed over the overall area including the transparent second electrode. The materials of the components and the liquid crystal material of the liquid crystal display apparatus of the transmission type may be known materials or members. It is to be noted that the switching element may be a three-terminal element such as a MOS FET or a thin film transistor (TFT) or a two-terminal element such as a MIM element, a barrister element or a diode formed on a single crystal silicon semiconductor substrate. Or, the liquid crystal display apparatus may have a matrix electrode configuration wherein a plurality of scanning electrodes extend in a first direction and a plurality of data electrodes extend in a second direction. In a liquid crystal display apparatus of the transmission type, illuminating light from the light source enters from the second substrate and goes out from the first substrate. On the other hand, in a liquid crystal display apparatus of the reflection type, illuminating light from the light source enters from the first substrate and is reflected by the second electrode (pixel electrode) formed on the inner face of the second substrate, whereafter it goes out from the first substrate. The apertures can be formed, for example, by forming an insulating material layer opaque to the illuminating light from the light source between the transparent second electrode and the associated orientation film and forming apertures in the insulating material layer. It is to be noted that the liquid crystal display apparatus of the reflection type may be a liquid crystal display apparatus of the LCOS (Liquid Crystal on Silicon) type.

The three-dimensional image display apparatus of the present embodiment may include an optical section for projecting the conjugate image formed by the conjugate image forming means or may include an optical section provided rearwardly of the third lens for projecting an image formed by the third lens.

In the three-dimensional image display apparatus of the present embodiment, where the number P×Q of pixels of a two-dimensional image is represented by (P, Q), several values of the resolution for image display can be used as the values of (P. Q) such as VGA (640, 480), S-VGA (800, 600), XGA (1,024, 768), APRC (1,152, 900), S-XGA (1,280, 1,024), U-XGA (1,600, 1,200), HD-TV (1,920, 1,080), and Q-XGA (2,048, 1,536) as well as (1,920, 1,035), (720, 480) and (1,280, 960). However, the values of (P×Q) are not limited to any of the above-specified values.

In summary, in the three-dimensional image display apparatus according to the first or second embodiment of the present invention, two-dimensional images are produced by the optical modulation means or the two-dimensional image forming apparatus based on light beams or illuminating light beams successively emitted from the different light emitting positions of the light source and having different incoming directions from each other. Further, spatial frequencies of the produced two-dimensional images are emitted along a plurality of diffraction angles corresponding to different diffraction orders generated from each of the pixels or the like. Then, the spatial frequencies are Fourier transformed by the Fourier transform image forming means or the first lens to produce and form a number of Fourier transform images or diffraction light beams corresponding to the number of diffraction orders thereby to finally reach an observer. The image which finally reaches the observer includes components of the incoming directions of the light beams or illuminating light beams to the optical modulation means or the two-dimensional image forming apparatus. Then, as such operations as described above are successively repeated in a time series, a group of light beams, for example, LEP_{Total} light beams, emitted from the Fourier transform image forming means or the first lens can be produced and scattered in a spatially very high density and besides in a state distributed in a plurality of directions. As a result, a stereoscopic image of a texture proximate to that of a physical solid in the real world can be obtained from the light beam group based on a light beam reproduction method, which is not available in the past and efficiently controls directional components of light beams for forming a stereoscopic image, without giving rise to increase of the overall size of the three-dimensional image display apparatus.

Besides, in the three-dimensional image display apparatus of the present embodiment, if a stereoscopic image is formed based on 0th-order diffraction light, then a bright and clear stereoscopic image of high quality can be obtained.

Further, where the light detection means is provided, the light emitting state of the light source can be monitored. Consequently, it is possible to suppress occurrence of quality deterioration of the picture quality arising from a dispersion of the light emitting state or from a secular change.

The above and other desire, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a schematic view showing a configuration of a three-dimensional image display apparatus according to a working example 1 of the present invention on a yz plane;

FIG. 2 is a schematic view showing part of the three-dimensional image display apparatus of FIG. 1 in an enlarged scale;

FIG. 3 is a schematic perspective view illustrating arrangement of components of the three-dimensional image display apparatus of FIG. 1;

FIG. 4 is a schematic view showing part of the three-dimensional image display apparatus of FIG. 1 in an enlarged scale;

FIGS. 5A and 5B are schematic views illustrating different states wherein a plurality of diffraction light beams of different diffraction orders are produced by optical modulation means or two-dimensional image display forming apparatus;

FIG. 6 is a schematic front elevational view of a light source;

FIG. 7 is a schematic front elevational view of a spatial filter;

FIG. 8 is a waveform diagram illustrating timings of formation of two-dimensional images by the optical modulation means or two-dimensional image forming apparatus and opening and closing timings of different apertures of Fourier transform image selection means or spatial filter;

FIG. 9 is a schematic view illustrating spatial filtering by the Fourier transform image selection means or spatial filter in a time series;

FIG. 10 is a schematic view showing an image obtained as a result of the spatial filtering illustrated in FIG. 9;

FIG. 11 is a schematic view of part of a three-dimensional image display apparatus of a working example 2 of the present invention on a yz plane;

FIG. 12 is a similar view but showing part of a modification to the three-dimensional image display apparatus of FIG. 11 on the yz plane;

FIG. 13 is a schematic view of part of a three-dimensional image display apparatus of a working example 3 of the present invention on a yz plane;

FIG. 14 is a similar view but showing part of a modification to the three-dimensional image display apparatus of FIG. 13 on the yz plane;

FIG. 15 is a block diagram of a control circuit for controlling operation of a two-dimensional image forming apparatus and a light source;

FIG. 16 is a schematic view of another modification to the three-dimensional image display apparatus of FIG. 13;

FIG. 17 is a similar view but showing a further modification to the three-dimensional image display apparatus of FIG. 13;

FIG. 18 is a block diagram showing the two-dimensional image forming apparatus to which light detection means is attached;

FIG. 19 is a schematic view showing a three-dimensional image display apparatus of a modification to the working example 1 on the yz plane;

FIG. 20 is an enlarged schematic view of part of the modified three-dimensional image display apparatus of FIG. 19 where a certain light emitting element is in a light emitting state;

FIG. 21 is a similar view but showing part of the modified three-dimensional image display apparatus of FIG. 19 where another certain light emitting element is in a light emitting state;

FIG. 22 is a similar view but showing part of the modified three-dimensional image display apparatus of FIG. 19 where a further certain light emitting element is in a light emitting state;

FIGS. 23A and 23B are schematic views showing part of modifications to the three-dimensional image display apparatus of the working example 1 on the yz plane;

FIG. 24 is a schematic view showing part of a still further modification to the three-dimensional image display apparatus of the working example 1;

FIG. 25 is a schematic perspective view showing a three-dimensional image display apparatus of the multi-unit type wherein a plurality of three-dimensional image display apparatus of the working example 1 are combined; and

FIG. 26 is a schematic perspective view showing an example of a configuration of a three-dimensional display apparatus in the related art.

### DETAILED DESCRIPTION OF THE PREFERRED EMBODIMENTS

In the following, the present invention is described in connection with working examples thereof shown in the accompanying drawings.

### WORKING EXAMPLE 1

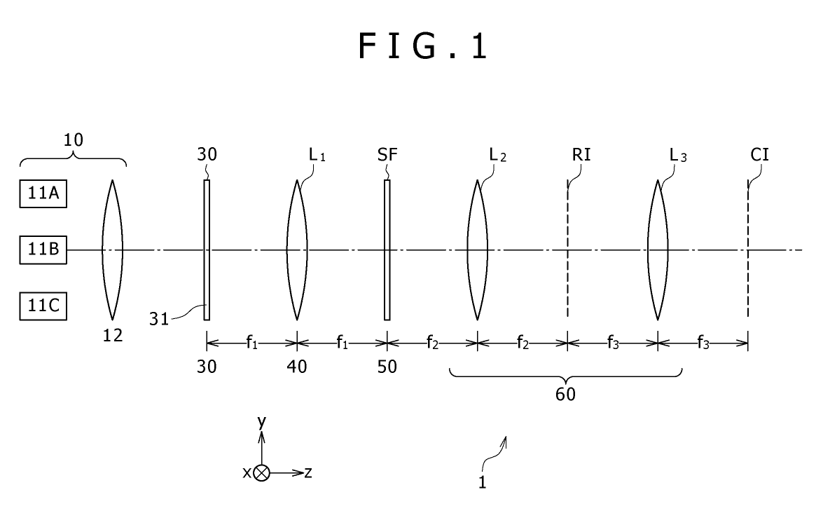

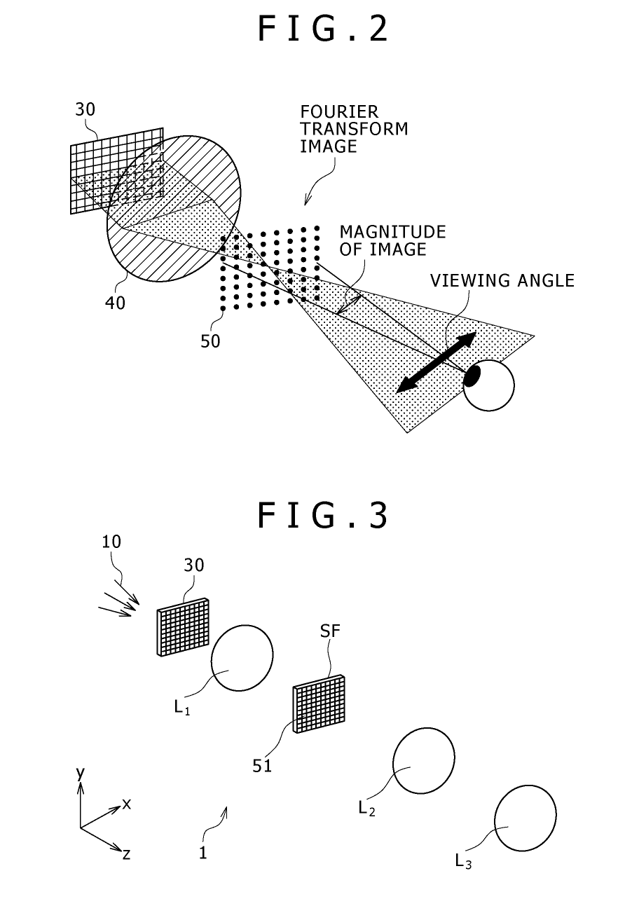

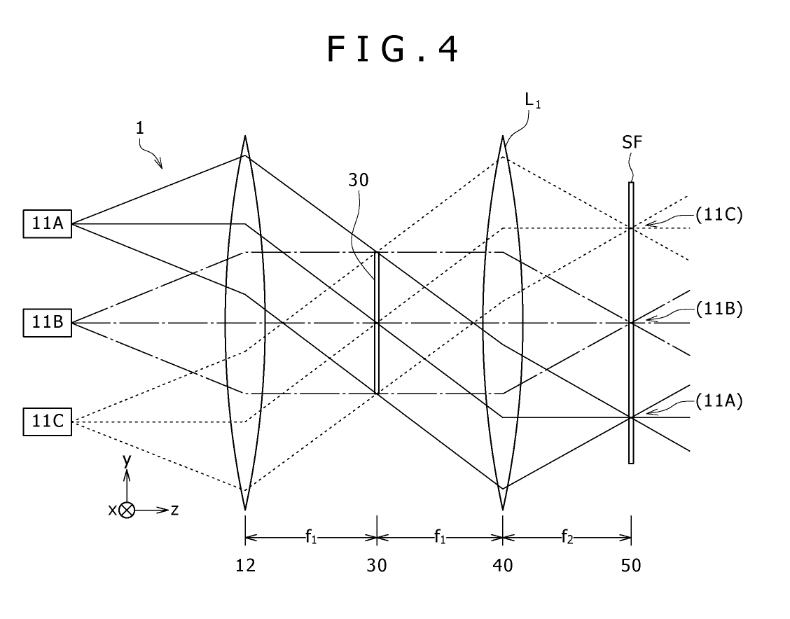

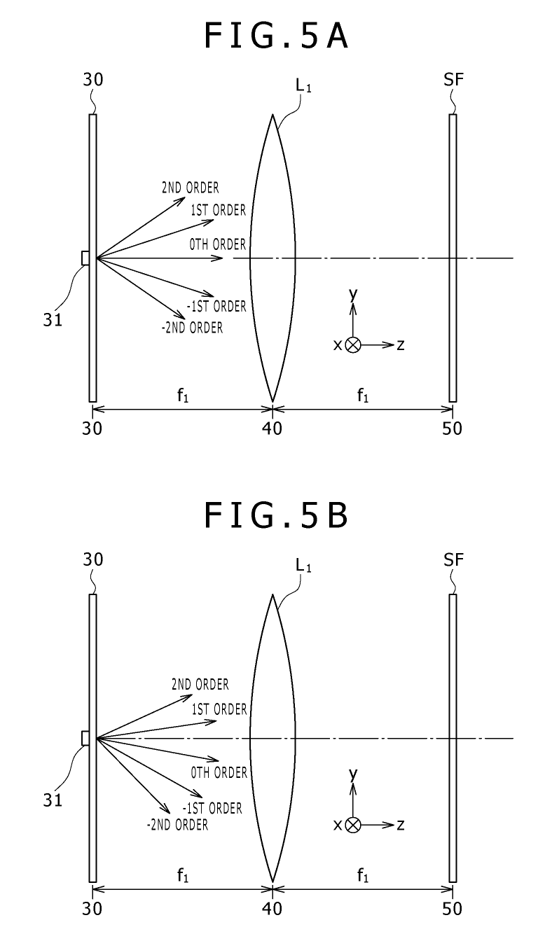

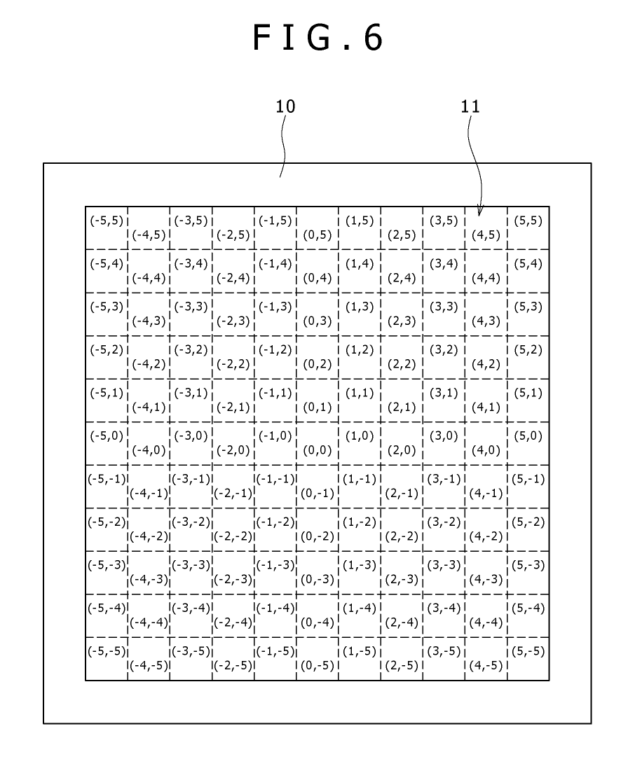

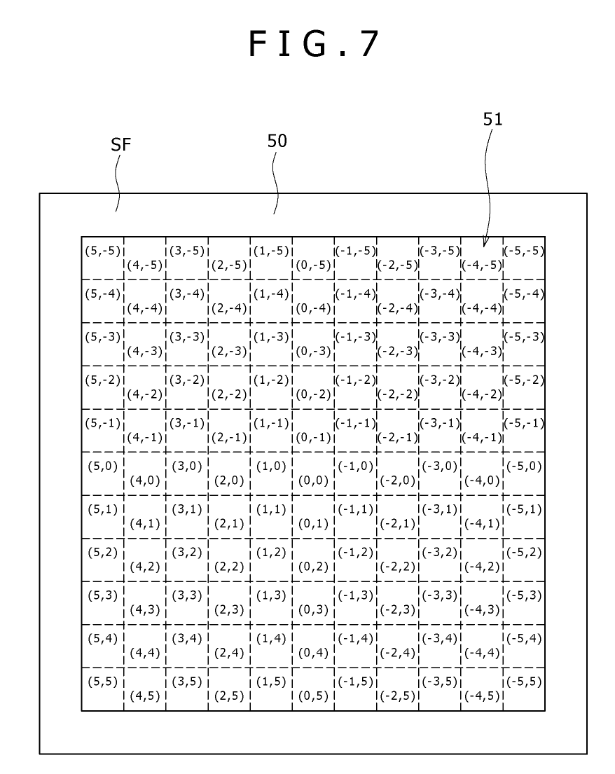

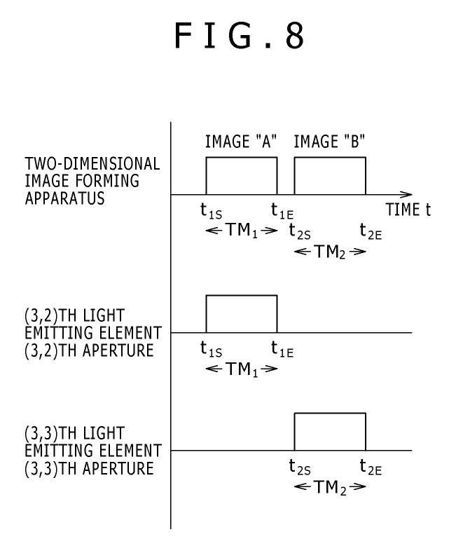

The working example 1 of the present invention is directed to a three-dimensional image display apparatus according to first and second embodiments of the present invention. FIG. 1 schematically shows the three-dimensional image display apparatus according to the working example 1 which displays a single color image. It is to be noted that, in FIG. 1, the optical axis is set to a z axis, and Cartesian coordinates in a plane perpendicular to the z axis are taken on an x axis and a y axis. Further, the direction parallel to the x axis is represented as X direction and the direction parallel to the y axis is represented as Y direction. The X direction is taken, for example, as a horizontal direction of the three-dimensional image display apparatus, and the Y direction is taken, for example, as a vertical direction of the three-dimensional image display apparatus. Here, FIG. 1 is a schematic view showing the three-dimensional image display apparatus of the working example 1 on a yz plane. Also where the three-dimensional image display apparatus of the working example 1 is viewed on an xz plane, it exhibits a schematic view substantially similar to that of FIG. 1. Meanwhile, FIG. 2 schematically shows the three-dimensional image display apparatus of the working example 1 as viewed in an oblique direction, and FIG. 3 schematically illustrates an arrangement state of components of the three-dimensional image display apparatus of the working example 1. It is to be noted that, in FIG. 2, most of the components of the three-dimensional image display apparatus are omitted, and also a beam of light is shown in a simplified form, different from FIGS. 1 and 3. Further, FIG. 2 shows only part of a light beam emitted from a two-dimensional image forming apparatus. Furthermore, optical modulation means or two-dimensional image forming apparatus, Fourier transform image forming means or first lens and Fourier transform image selection means or spatial filter are schematically shown in an enlarged scale in FIGS. 4, 5A and 5B, respectively, together with associated elements. Further, a schematic front elevational view of a beam of light is shown in FIG. 6, and a schematic front elevational view of the spatial filter is shown in FIG. 7.

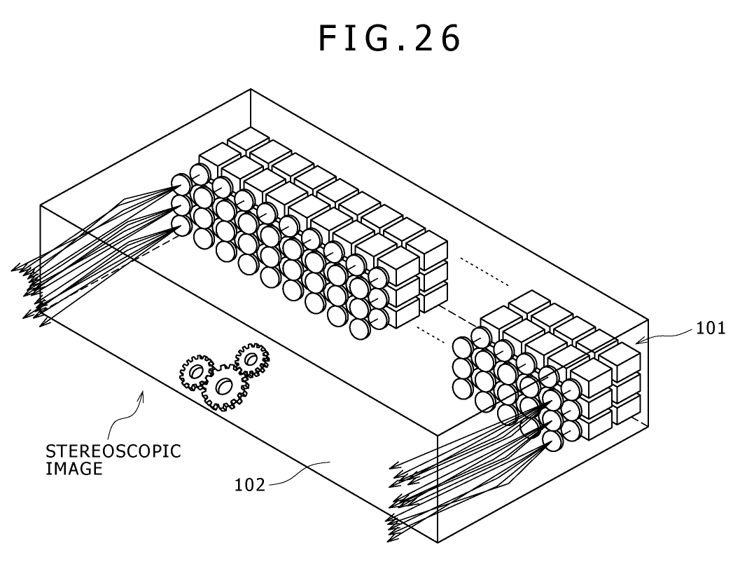

In display of a stereoscopic image by a light beam reproduction method in the related art, in order to emit a plurality of beams of light from a virtual origin on the surface of a virtual physical solid existing at an arbitrary position, it is necessary to prepare an apparatus which can provide beams of light which are emitted at various angles in advance. For example, in an apparatus shown in FIG. 26, a large number of (for example, U₀×V₀) projector units 101 has to be disposed parallelly in a horizontal direction and a vertical direction.

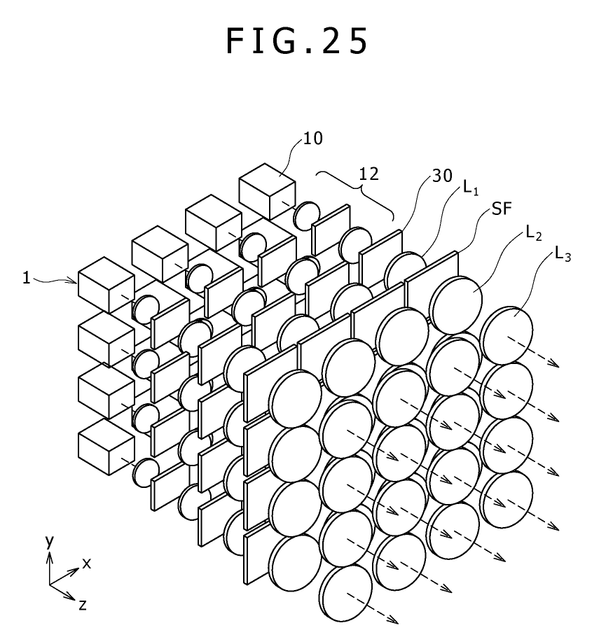

Meanwhile, in the three-dimensional image display apparatus 1 of the working example 1, the three-dimensional image display apparatus itself which includes such components as seen in FIG. 1 and so forth can generate and form a greater amount of light beams having a higher spatial density when compared with the related art. The three-dimensional image display apparatus 1 of the working example 1 by itself has functions equivalent to those of the apparatus shown in FIG. 26 which includes a large number of (U₀×V₀) projector units 101 disposed parallelly in a horizontal direction and a vertical direction. It is to be noted that, for example, where it is intended to employ a multi-unit system, it is necessary to dispose a number of (for example, 4×4=16) three-dimensional image display apparatus 1 of the working example 1 equal to the number of divisional three-dimensional images as seen from a schematic view of FIG. 25.

Where the three-dimensional image display apparatus 1 of the working example 1 is described in connection with components of the three-dimensional image display apparatus according to the first embodiment of the present invention, it includes:

a light source 10 configured to emit light from a plurality of light emitting positions disposed discretely or spaced from each other;

an optical modulation section 30 including a plurality of (P×Q) pixels 31 and configured such that light beams or illuminating light beams successively emitted from the different light emitting positions of the light source 10 and incoming in different directions from each other are modulated by the pixels 31 to generate two-dimensional images and spatial frequencies of the generated two-dimensional images are emitted along diffraction angles corresponding to a plurality of (totaling M×N) diffraction orders generated from the pixels 31; and

a Fourier transform image forming section 40 configured to Fourier transform the spatial frequencies of the two-dimensional images emitted from the optical modulation section 30 to produce a number of Fourier transform images corresponding to the number of (totaling M×N) diffraction orders to form the Fourier transform images; as well as

a conjugate image forming section 60 configured to form conjugate images of the Fourier transform images formed by the Fourier transform image forming section 40.

Where the three-dimensional image display apparatus 1 of the working example 1 is described in connection with components of the three-dimensional image display apparatus according to the second embodiment of the present invention, it includes:

a light source 10 configured to emit light from a plurality of light emitting positions disposed discretely or spaced from each other;

a two-dimensional image forming apparatus 30 having P×Q apertures arrayed in a two-dimensional matrix along an X direction and a Y direction and configured to control passage for each of the apertures of light beams or illuminating light beams successively emitted from the different light emitting positions of the light source 10 and having different incoming directions to produce two-dimensional images and generate a plurality of (totaling M×N) diffraction light beams of different diffraction orders for each of the apertures based on the two-dimensional images;

a first lens L₁ having a front side focal plane, which is a focal plane on the light source side, on which the two-dimensional image forming apparatus 30 is disposed;

a second lens L₂ having a front side focal plane, which is a focal plane on the light source side, on which the rear side focal plane, which is a focal plane on the observer side, of the first lens L₁ is positioned; and

a third lens L₃ having a front side focal plane on which the rear side focal plane of the second lens L₂ is positioned.

Here, the spatial frequencies of the two-dimensional images correspond to image information having a carrier frequency equal to the spatial frequency of the pixel structure.

In the three-dimensional image display apparatus 1 of the working example 1, the light source 10 includes light emitting elements 11, and light advancing direction changing means for changing the incoming direction of light emitted from the light emitting element 11 and directed so as to enter optical modulation means or two-dimensional image forming apparatus 30. Here, the light source 10 includes a plurality of light emitting elements 11 each in the form of a light emitting diode or LED which are arrayed in a two-dimensional matrix. It is to be noted that the number of light emitting elements 11 arrayed in a two-dimensional matrix is U₀′×V₀′ and the number of light emitting positions disposed discretely on the light source 10 is U₀×V₀ (where U₀=U₀′ and V₀=V₀′). In the working example 1, P=1,024 and Q=768, and U₀=11 and V₀=11. It is to be noted that the numbers of the light emitting elements 11 and the light emitting positions are not limited to the specific numbers. Further, the light advancing direction changing means is formed from refraction type optical means, particularly a lens, and more particularly a collimator lens 12. Here, the light emitting elements 11 are disposed in the proximity of the front side focal plane of the collimator lens 12 so that the emitting direction when light beams in the form of parallel light beams emitted from the light emitting elements 11 and incoming to the collimator lens 12 go out from the collimator lens 12 can be changed stereoscopically. As a result, the incoming angles of light beams or illuminating light beams incoming from the optical modulation means or two-dimensional image forming apparatus 30 can be changed stereoscopically (refer to FIG. 4). It is to be noted that, while the emitting directions of light beams emitted from the light emitting elements 11 in the working example 1 are same as each other, particularly, in parallel to the optical axis, they may otherwise be different from each other. Or, in other words, a lens, particularly the collimator lens 12, is interposed between the light emitting elements 11 serving as a light source and the optical modulation means or two-dimensional image forming apparatus 30, and the light emitting elements 11 are positioned on or in the proximity of the front side focal plane of the collimator lens 12.

The z axis which corresponds to the optical axis passes the center of the components of the three-dimensional image display apparatus 1 of the working example 1 and besides intersects perpendicularly with the components of the three-dimensional image display apparatus 1. If the components of the three-dimensional image display apparatus according to the first embodiment of the present invention and the components of the three-dimensional image display apparatus according to the second embodiment of the present invention are compared with each other, then the optical modulation section 30 corresponds the two-dimensional image forming apparatus 30; the Fourier transform image forming section 40 corresponds to the first lens L₁; a Fourier transform image selection section 50 hereinafter described corresponds to a spatial filter SF; the inverse Fourier transform means corresponds to the second lens L₂; and the conjugate image forming section 60 corresponds to the second lens L₂ and the third lens L₃. Therefore, for the convenience of description, the following description is given using the terms of the two-dimensional image forming apparatus 30, first lens L₁, spatial filter SF, second lens L₂ and third lens L₃.

A state wherein fluxes of light emitted from light emitting elements 11A, 11B and 11C which compose the light source 10 pass through the two-dimensional image forming apparatus 30, first lens L₁ and spatial filter SF is schematically illustrated in FIG. 4. Referring to FIG. 4, the light flux emitted from the light emitting element 11A of the light source 10 is indicated by solid lines; the light flux emitted from the light emitting element 11B is indicated by alternate long and short dash lines; and the light flux emitted from the light emitting element 11C is indicated by alternate long and two short dashes lines. Meanwhile, the positions of images on the spatial filter SF formed from the illuminating light beams emitted from the light emitting elements 11A, 11B and 11C are denoted by reference characters 11A, 11B and 11C, respectively. It is to be noted that the position numbers (hereinafter described) of the light emitting elements 11A, 11B and 11C of the light source 10 are, for example, (5, 0), (0, 0) and (−5, 0), respectively. Here, if a certain one of the light emitting elements is in a turned-on state, that is, a light emitting state, then all of the other light emitting elements are in a turned-off state, that is, a no-light emitting state.

As described hereinabove, the collimator lens 12 is disposed between the light emitting elements 11 and the two-dimensional image forming apparatus 30. The two-dimensional image forming apparatus 30 is illuminated with illuminating light beams emitted from the light emitting elements 11 and passing through the collimator lens 12. However, the incoming direction of the illuminating light beams to the two-dimensional image forming apparatus 30 differs stereoscopically depending upon the two-dimensional positions (light emitting positions) of the light emitting elements 11.

The optical modulation section 30 is formed from a two-dimensional spatial optical modulator having a plurality of pixels 31 arrayed two-dimensionally, and each of the pixels 31 has an aperture. Here, the two-dimensional spatial optical modulator or two-dimensional image forming apparatus 30 is particularly formed from a liquid crystal display apparatus of the transmission type having P×Q pixels 31 disposed two-dimensionally, that is, disposed in a two-dimensional matrix along the X direction and the Y direction, and each of the pixels 31 has an aperture. It is to be noted that the shape of the aperture in plan is a rectangular shape. Where the apertures have a rectangular planar shape, Fraunhofer diffraction occurs and M×N diffraction light beams are produced. In particular, by such apertures, the amplitude (intensity) of the incoming light waves is modulated periodically such that amplitude gratings from which a light amount distribution coincident with a light transmission factor distribution of gratings are formed.

One pixel 31 is formed from a region in which a transparent first electrode and a transparent second electrode overlap with each other and which includes a liquid crystal cell. Then, the liquid crystal cell operates as a kind of optical shutter or light valve, that is, the light transmission factor or numerical aperture of each pixel 31 is controlled, to control the light transmission factor of the illuminating light emitted from the light source 10, and as a whole, a two-dimensional image is obtained. A rectangular aperture is provided in the overlapping region of the transparent first and second electrodes, and when the illuminating light emitted from the light source 10 passes through the aperture, Fraunhofer diffraction occurs. As a result, M×N diffraction light beams are generated from each of the pixels 31. In other words, since the number of pixels 31 is P×Q, it is considered that totaling P×Q×M×N diffraction light beams are generated. In the two-dimensional image forming apparatus 30, spatial frequencies of a two-dimensional image are emitted along diffraction angles corresponding to a plurality of diffraction orders, totaling M×N orders, generated from each pixel 31. It is to be noted that the diffraction angles differ also depending upon the spatial frequencies of the two-dimensional image.

In the three-dimensional image display apparatus 1 of the working example 1, the Fourier transform image forming section 40 is formed from a lens, that is, the first lens L₁, and the two-dimensional image forming apparatus 30 is disposed on the front side focal plane, which is the focal plane on the light source side, of this lens, that is, the first lens L₁.

The three-dimensional image display apparatus 1 of the working example 1 includes a Fourier transform image selection section 50 for selecting a Fourier transform image corresponding to a desired diffraction order from among a number of generated Fourier transform images corresponding to a plural number of diffraction orders. Here, the Fourier transform image selection section 50 is disposed at a position at which Fourier transform images are formed, that is, an XY plane or an image forming plane on which Fourier transform images are formed by the Fourier transform image forming section 40. In particular, the Fourier transform image selection section 50 is disposed on the rear side focal plane, that is, on the focal plane on the observer side, of the lens which forms the Fourier transform image forming section 40, that is, the first lens L₁. Or, in other words, the three-dimensional image display apparatus 1 includes a spatial filter SF having a number of apertures 51, which can be controlled to be opened and closed, corresponding to the number of light emitting positions of the light source 10 and positioned on the rear side focal plane of the first lens L₁. In particular, the Fourier transform image selection section 50 or spatial filter SF has a number of (U₀×V₀=LEP_{Total}) apertures 51 corresponding to the number (U₀×V₀=LEP_{Total}) of light emitting positions of the light source 10 disposed discretely.

Here, the Fourier transform image selection section 50 or spatial filter SF can be formed more particularly from a liquid crystal display apparatus of the transmission type or the reflection type which uses dielectric liquid crystal having, for example, U₀×V₀ pixels or a MEM of the two-dimensional type including an apparatus wherein movable mirrors are arrayed two-dimensionally. Here, for example, opening and closing control of the apertures 51 can be carried out by causing the liquid crystal cell to operate as a kind of optical shutter or light valve or by movement/non-movement of the movable mirrors. In the Fourier transform image selection section 50 or spatial filter SF, a Fourier transform image corresponding to a desired diffraction order (0th order) can be selected by placing a desired aperture 51 (particularly an aperture 51 through which 0th order diffraction light is to pass) into an open state in synchronism with a production timing of a two-dimensional image by the two-dimensional image forming apparatus 30.

The three-dimensional image display apparatus 1 further includes inverse Fourier transform means, particularly the second lens L₂, for inverse Fourier transforming a Fourier transform image formed by the Fourier transform image forming section 40 to form a real image R1 of a two-dimensional image formed by the two-dimensional image forming apparatus 30.

In the working example 1, each of the first lens L₁, second lens L₂ and third lens L₃ is particularly formed from a convex lens.

As described hereinabove, the two-dimensional image forming apparatus 30 is disposed on the front side focal plane, that is, the focal plane on the light source side, of the first lens L₁ having the focal distance f₁, and the spatial filter SF which can be temporally controlled to open and close for spatially and temporally filtering a Fourier transform image is disposed on the rear side focal plane, that is, the focal plane on the observer side, of the first lens L₁. Then, a number of Fourier transform images corresponding to a plural number of diffraction orders are produced by the first lens L₁, and the Fourier transform images are formed on the spatial filter SF. It is to be noted that, in FIG. 2, 64 Fourier transform images are shown in the form of a dot for the convenience of illustration. Then, one of the large number of Fourier transform images formed in FIG. 2 can pass through one of the apertures 51 which is controlled to an open state in response to the light emitting position.

A schematic front elevational view of the light source 10 formed from a plurality of light emitting elements arrayed in a two-dimensional matrix is shown in FIG. 6, and a schematic front elevational view of the spatial filter SF formed from a liquid crystal display apparatus is shown in FIG. 7. In FIGS. 6 and 7, numerical values (u, v) represent position numbers of the light emitting elements which compose the light source 10 or of the apertures 51 which compose the spatial filter SF. In particular, for example, to the (3, 2)th aperture 51, only a desired Fourier transform image, for example, a Fourier transform image corresponding to the 0th-order diffraction, of a two-dimensional image formed from a light emitting element positioned at the (3, 2)th position comes in, and it passes through the (3, 2)th aperture 51. Fourier transform images other than the desired Fourier transform images of the two-dimensional image formed from the light emitting element positioned at the (3, 2)th position are intercepted by the spatial filter SF. On the front side focal plane of the second lens L₂ having a focal distance f₂, the spatial filter SF is disposed. Further, the second lens L₂ and the third lens L₃ are disposed such that the rear side focal plane of the second lens L₂ and the front side focal plane of the third lens L₃ having a focal distance f₃ coincide with each other.

The planar shape of the apertures 51 of the spatial filter SF may be determined based on the shape of the Fourier transform images. Further, the apertures 51 may be provided, for example, for Fourier transform images corresponding to the 0th order diffraction such that the peak position of a plane wave component of a Fourier transform image may be the center. As a result, a peak of the light intensity of a Fourier transform image is positioned at the central position of each aperture 51. In particular, the apertures 51 may be formed such that all of the positive and negative highest spatial frequencies of a two-dimensional image can pass therethrough centering on a periodical pattern of Fourier transform images where the spatial frequency of the two-dimensional image is the lowest spatial frequency component or plane wave component.

As described above, the conjugate image forming section 60 is particularly formed from the second lens L₂ and the third lens L₃. The second lens L₂ having the focal distance f₂ inverse Fourier transforms a Fourier transform image filtered by the spatial filter SF to form a real image RI of the two-dimensional image formed by the two-dimensional image forming apparatus 30. In particular, the second lens L₂ is disposed such that the real image RI of the two-dimensional image formed by the two-dimensional image forming apparatus 30 is formed on the rear side focal plane of the second lens L₂. The magnification of the real image RI obtained here with respect to the two-dimensional image of the two-dimensional image forming apparatus 30 can be varied by arbitrarily selecting the focal distance f₂ of the second lens L₂. Further, the third lens L₃ having the focal distance f₃ forms a conjugate image CI of the Fourier transform image filtered by the spatial filter SF.

Here, since the rear side focal plane of the third lens L₃ is a conjugate plane of the spatial filter SF, this is equivalent to that the two-dimensional image produced by the two-dimensional image forming apparatus 30 is outputted from a portion on the spatial filter SF corresponding to one of the apertures 51. Then, the amount of light beams to be outputted corresponds to the number of pixels (P×Q) and to the number of light beams which pass through the spatial filter SF. In particular, the situation that the amount of light beams which pass through the spatial filter SF is decreased by later passage or reflection of the light through or by a component of the two-dimensional image display apparatus does not substantially occur. Further, although the conjugate image CI of the Fourier transform image is formed on the rear side focal plane of the third lens L₃, since directional components of the conjugate image of the two-dimensional image are defined by directional components of illuminating light emitted from the light source 10 and incoming to the two-dimensional image forming apparatus 30, it can be regarded that the light beams are disposed regularly two-dimensionally on the rear side focal plane of the third lens L₃. In other words, this is generally equivalent to a state that a plurality of (U₀×V₀) projector units 101 shown in FIG. 26 are disposed on the rear side focal plane of the third lens L₃, that is, the plane on which the conjugate image CI is formed.

As schematically shown in FIGS. 5A and 5B, totaling M×N sets of diffraction light beams are produced along the X direction and the Y direction by one pixel 31 of the two-dimensional image forming apparatus 30. It is to be noted that, while only diffraction light beams including the 0th order light beam (n₀=0), ±1st order light beams (n₀=±1) and ±2nd order light beams (n₀=±2) are illustrated representatively in FIGS. 5A and 5B, actually higher order (for example, ±5th order) diffraction light beams are formed, and a stereoscopic image is finally formed based on part of such diffraction light beams, particularly, for example, based on the 0th order light beams. It is to be noted that FIG. 5A schematically illustrates diffraction light beams produced from a light beam emitted from the light emitting element 11B, and FIG. 5B schematically illustrates diffraction light beams emitted from the light emitting element 11A. Here, on diffraction light beams or light fluxes of each diffraction order, all image information, that is, information of all pixels, of the two-dimensional image formed by the two-dimensional image forming apparatus 30 is intensified. A plurality of light beams produced by diffraction from the same pixel of the two-dimensional image forming apparatus 30 all have the same image information. In other words, in the two-dimensional image forming apparatus 30 formed from a liquid crystal display apparatus of the transmission type having P×Q pixels 31, illuminating light from the light source 10 is modulated by the pixels 31 to produce a two-dimensional image, and besides spatial frequencies of the produced two-dimensional image are emitted from diffraction angles corresponding to a plurality of, totaling M×N, diffraction orders produced from each pixel 31. In other words, a kind of M×N copies of the two-dimensional image are emitted along diffraction angles corresponding to a plurality of, totaling M×N, diffraction orders from the two-dimensional image forming apparatus 30.

The spatial frequencies of the two-dimensional image on which all image information of the two-dimensional image formed by the two-dimensional image forming apparatus 30 is intensified are Fourier transformed by the first lens L₁ to produce a number of Fourier transform images corresponding to a plural number of diffraction orders produced from each pixel 31. Then, only a predetermined Fourier transform image, for example, a Fourier transform image corresponding to the 0th order diffraction, from among the Fourier transform images, is passed through the spatial filter SF. Then, the selected Fourier transform image is inverse Fourier transformed by the second lens L₂ to form a conjugate image of the two-dimensional image produced by the two-dimensional image forming apparatus 30. The conjugate image of the two-dimensional image enters the third lens L₃, by which a conjugate image CI is formed. It is to be noted that, while the spatial frequencies of the two-dimensional image correspond to image information whose carrier frequency is the spatial frequency of the pixel structure, only a region of the image information whose carrier is a 0th order plane wave, that is, a region up to a spatial frequency equal to ½ the spatial frequency of the pixel structure in the maximum, is obtained as 1st order diffraction where the 0th order diffraction of the pixel structure is the carrier frequency, and the spatial frequencies lower than one half the spatial frequency of the pixel structure or aperture structure of the optical modulation means pass through the spatial filter SF. In this manner, the conjugate image of the two-dimensional structure formed by the third lens L₃ does not include the pixel structure of the two-dimensional image forming apparatus 30, but includes all spatial frequencies of the two-dimensional image produced by the two-dimensional image forming apparatus 30. Then, since a Fourier transform image of the spatial frequency of the conjugate image of the two-dimensional image is produced by the third lens L₃, Fourier transform images can be formed in a spatially high density.

In the following, the timing of opening and closing control of the apertures 51 of the spatial filter SF is described.

In the spatial filter SF, in order to select a Fourier transform image corresponding to a desired diffraction order, opening and closing control of the apertures 51 is carried out in synchronism with outputting of an image from the two-dimensional image forming apparatus 30. This operation is described with reference to FIGS. 8, 9 and 10. It is to be noted that the uppermost stage of FIG. 8 illustrates a timing of outputting of an image from the two-dimensional image forming apparatus 30, and the middle stage of FIG. 8 illustrates opening and closing timings of the (3, 2)th aperture 51 of the spatial filter SF while the lower stage of FIG. 8 illustrates opening and closing timings of the (3, 3)th aperture 51.

It is assumed that, as seen in FIG. 8, in the two-dimensional image forming apparatus 30, an image “A” is displayed within a period TM₁ from time t_{1S} to time t_{1E}, and another image “B” is displayed within another period TM₂ from time t_{2S} to time t_{2E}. In this instance, in the light source 10, only the (3, 2)th light emitting element is placed into a light emitting state within the period TM₁, and only the (3, 3)th light emitting element is placed into a light emitting state within the period TM₂. In this manner, different illuminating light beams successively emitted from a plurality of light emitting positions disposed discretely and having different incoming directions to the two-dimensional image forming apparatus 30 are used and besides are modulated individually by the pixels 31. Meanwhile, in the spatial filter SF, the (3, 2)th aperture 51 is placed into an open state within the period TM₁, and the (3, 3)th aperture 51 is placed into an open state within the period TM₂ as seen in FIG. 8. In this manner, different image information can be added to Fourier transform images which are produced by the first lens L₁ as different diffraction order images from the same pixel 31 of the two-dimensional image forming apparatus 30. In other words, within the period TM₁, a Fourier transform image having the 0th diffraction order obtained at a certain pixel 31 of the two-dimensional image forming apparatus 30 by placing the (3, 2)th light emitting element into a light emitting state to includes image information relating to the image “A” and incoming direction information of the illuminating light to the two-dimensional image forming apparatus 30. On the other hand, within the period TM₂, a Fourier transform image having the 0th diffraction order obtained at the same certain pixel of the two-dimensional image forming apparatus 30 by placing the (3, 3)th light emitting element into a light emitting state includes image information relating to the image “B” and incoming direction information of the illuminating light to the two-dimensional image forming apparatus 30.

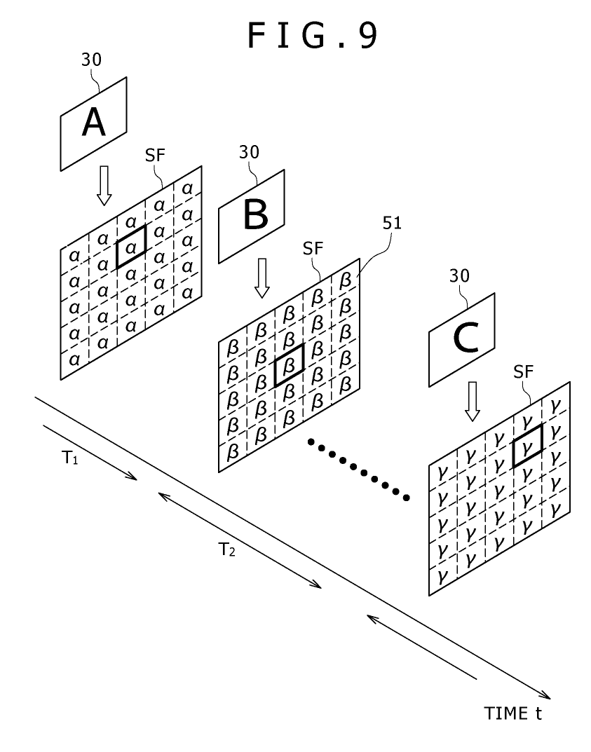

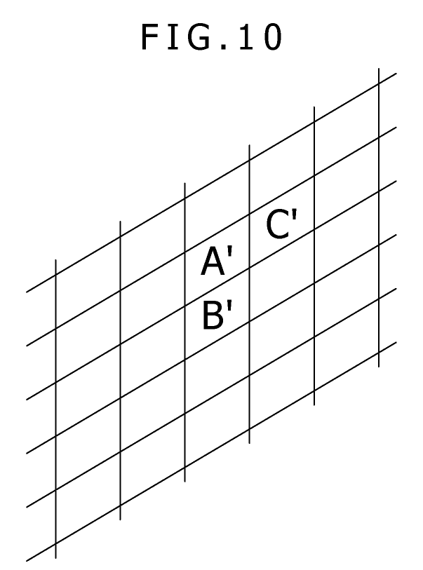

FIG. 9 schematically illustrates a timing of image formation and a timing of control of the apertures 51 on the two-dimensional image forming apparatus 30. Referring to FIG. 9, within the period TM₁, the two-dimensional image forming apparatus 30 displays the image “A”, and M×N Fourier transform images are condensed as a Fourier transform image “α” centering on the corresponding (3, 2)th aperture 51 of the spatial filter SF. Within the period TM₁, since only the (3, 2)th aperture 51 is opened, only the Fourier transform image “α” having the 0th diffraction order passes through the spatial filter SF. Within the next period TM₂, the two-dimensional image forming apparatus 30 displays an image “β”, and M×N Fourier transform images are condensed similarly as a Fourier transform image “β” centering on the corresponding (3, 3)th aperture 51 of the spatial filter SF. Within the period TM₂, since only the (3, 3)th aperture 51 is opened, only the Fourier transform image “β” having the 0th diffraction order passes through the spatial filter SF. Thereafter, opening and closing control of the apertures 51 of the spatial filter SF is carried out in synchronism with every image forming timing of the two-dimensional image forming apparatus 30. It is to be noted that, in FIG. 9, an aperture 51 in the open state is surrounded by a solid line while the apertures 51 in the closed state are surrounded by a broken line. Further, since the Fourier transform images “α”, “β” and “γ” which each passes through an aperture 51 in the open state are images obtained based on the 0th order diffraction, they are bright. On the other hand, the Fourier transform images “α”, “β” and “γ” which collide with those apertures 51 which are in the closed state are dark because they are obtained based on the higher order diffraction. Accordingly, as occasion demands, the spatial filter SF is unnecessary. If the space occupied by the spatial filter SF is watched for a certain period of time, then a state wherein U₀×V₀ bright spots (Fourier transform images) are juxtaposed in a two-dimensional matrix, that is, a state similar to that shown in FIG. 2, would be observed.

Images obtained as a final output of the three-dimension image display apparatus 30 where image formation and opening and closing control of the apertures 51 of the two-dimensional image forming apparatus 30 are carried out at such timings as described above are schematically shown in FIG. 10. Referring to FIG. 10, an image “A′” is obtained as a result of passage through the spatial filter SF only of a Fourier transform image “α” of the 0th order diffraction when only the (3, 2)th light emitting element is in a light emitting state because only the (3, 2)th aperture 51 is opened. Another image “B′” is obtained as a result of passage through the spatial filter SF only of another Fourier transform image “β” of the 0th order diffraction when only the (3, 3)th light emitting element is in a light emitting state because only the (3, 3)th aperture 51 is opened. A further image “C′” is obtained as a result of passage through the spatial filter SF only of a further Fourier transform image “γ” of the 0th order diffraction when only the (4, 2)th light emitting element is in a light emitting state because only the (4, 2)th aperture 51 is opened. It is to be noted that the image shown in FIG. 10 is an image observed by the observer. While, in FIG. 10, different images are partitioned by solid lines, such solid lines are virtual lines. Further, although actually such images as shown in FIG. 10 are obtained not at the same time, since the changeover time between images is very short, they are observed by the eyes of the observer as if they were displayed simultaneously. For example, selection of U₀×V₀ images based on all of the light emitting positions disposed discretely is carried out within the display period of one frame. Further, although the images are shown displayed on a plane in FIG. 10, actually a stereoscopic image is observed by the observer.

In particular, as described hereinabove, for example, the images A′, B′, C′, . . . are successively outputted in a time series from the rear side focal plane of the third lens L₃. In particular, this is equivalent to that generally a plural number of projector units shown in FIG. 26 equal to the number of, particularly U₀×V₀, light emitting positions disposed discretely are disposed on the rear side focal plane of the third lens L₃, and images are outputted in a time series such that the image A′ is outputted from a certain projector unit, the image B′ is outputted from another projector unit and the image C′ is outputted from a further projector unit. Then, if the images are reproduced in a time series by the two-dimensional image forming apparatus 30 based on data of a large number of images formed by picking up a certain physical solid from various positions or directions or on data of images produced by a computer, then a stereoscopic image can be obtained based on the reproduced images.

The opening and closing control of the apertures 51 provided on the spatial filter SF may not be carried out for all apertures 51. In particular, the opening and closing control of the apertures 51 may be carried out, for example, for every other one of the apertures 51 or for those of the apertures 51 which are positioned at a desired position.

As described above, with the three-dimensional image display apparatus 1 of the working example 1, while a predetermined one of the light emitting elements 11 is turned on to emit light, a desired one of the apertures 51 of the Fourier transform image selection section 50 or spatial filter SF is opened. Accordingly, spatial frequencies of a two-dimensional image produced by the two-dimensional image forming apparatus 30 are emitted along a plurality of diffraction angles corresponding to different diffraction orders and Fourier transformed by the Fourier transform image forming section 40 or first lens L₁. Then, Fourier transform images obtained by such Fourier transform are filtered spatially and temporally by the Fourier transform image selection section 50 or spatial filter SF, and a conjugate image CI of the filtered Fourier transform image is formed. Consequently, a group of beams of light can be produced and scattered in a state wherein they are distributed in a plurality of directions in a spatially high density without inviting upsizing of the entire three-dimensional image display apparatus. Further, the individual beams of light which are components of the group of light beams can be temporally and spatially controlled independently of each other. Consequently, a stereoscopic image formed from beams of light proximate in quality to those of a physical solid in the real world can be obtained.

Further, with the three-dimensional image display apparatus 1 of the working example 1, since a light beam reproduction method is utilized, a stereoscopic image which satisfies such visual sensation functions as focal adjustment, convergence and motion parallax can be provided. Further, with the three-dimensional image display apparatus 1 of the working example 1, since illuminating light beams whose incoming directions to the two-dimensional image forming apparatus 30 differ depending upon a plurality of light emitting positions disposed discretely or in a spaced relationship from each other, when compared with the image outputting technique in the past, the number of light beams which can be controlled by a single image outputting device, that is, the two-dimensional image forming apparatus 30, can be made equal to the number of light emitting positions disposed discretely, that is, to U₀×V₀. Besides, with the three-dimensional image display apparatus 1 of the working example 1, since filtering is carried out spatially and temporally, a temporal characteristic of the three-dimensional image display apparatus can be converted into a spatial characteristic of the three-dimensional image display apparatus. Further, a stereoscopic image can be obtained without using a diffusion screen or the like. Furthermore, a stereoscopic image which looks appropriately from whichever direction it is observed can be provided. Further, since a group of light beams can be produced and scattered in a spatially high density, a spatial image of a high definition near to a visual confirmation limit can be provided.

### WORKING EXAMPLE 2

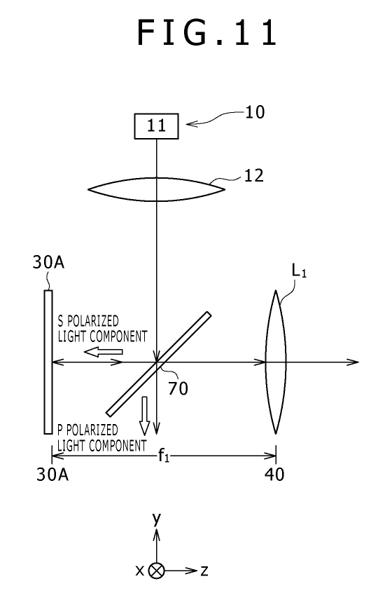

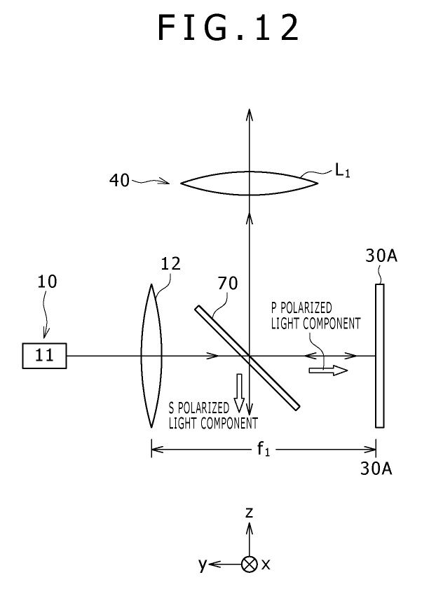

The working example 2 is a modification to the working example 1. The three-dimensional image display apparatus of the working example 2 is schematically shown in FIGS. 11 and 12. In the three-dimensional image display apparatus of the working example 1 described above, the two-dimensional image forming apparatus 30 of the light transmission type is used. On the other hand, in the three-dimensional image display apparatus of the working example 2, optical modulation means or two-dimensional image forming apparatus 30A of the reflection type is used. The optical modulation means or two-dimensional image forming apparatus 30A of the reflection type may particularly be, for example, a liquid crystal display apparatus of the reflection type.

In the three-dimensional image display apparatus of the working example 2 shown in FIG. 11, a beam splitter 70 is provided on the z axis which is an optical axis. The beam splitter 70 has a structure for passing or reflecting light depending upon the polarized light component. In particular, the beam splitter 70 reflects, for example, an S polarized light component of illuminating light emitted from the light source 10 toward the optical modulation means or two-dimensional image forming apparatus 30A of the reflection type, but passes a P polarized light component therethrough. Further, the beam splitter 70 passes modulated reflected light from the optical modulation means or two-dimensional image forming apparatus 30A therethrough. On the other hand, in the three-dimensional image display apparatus of the working example 2 shown in FIG. 12, the beam splitter 70 passes, for example, a P polarized light component of illuminating light emitted from the light source 10 therethrough and emits the P polarized light component toward the two-dimensional image forming apparatus 30A of the reflection type, but reflects an S polarized light component of the illuminating light. Further, the beam splitter 70 reflects modulated reflected light from the optical modulation means or two-dimensional image forming apparatus 30A. Except the features described, the configuration and structure of the three-dimensional image display apparatus of the working example 2 can be made similar to those of the three-dimensional image display apparatus of the working example 1. Therefore, detailed overlapping description of the configuration and structure is omitted herein to avoid redundancy.

It is to be noted that a configuration wherein a movable mirror is provided in each aperture, that is, a configuration formed from a two-dimensional type MEMS wherein movable mirrors are disposed in a two-dimensional matrix, can be adopted alternatively as the optical modulation means or two-dimensional image forming apparatus of the reflection type. In this instance, a two-dimensional image is formed by movement/non-movement of the movable mirrors, and besides, Fraunhofer diffraction is caused by the apertures. It is to be noted that, where a two-dimensional type MEMS is adopted, a beam splitter is not required, but illuminating light may be introduced in an oblique direction into the two-dimensional type MEMS.

### WORKING EXAMPLE 3

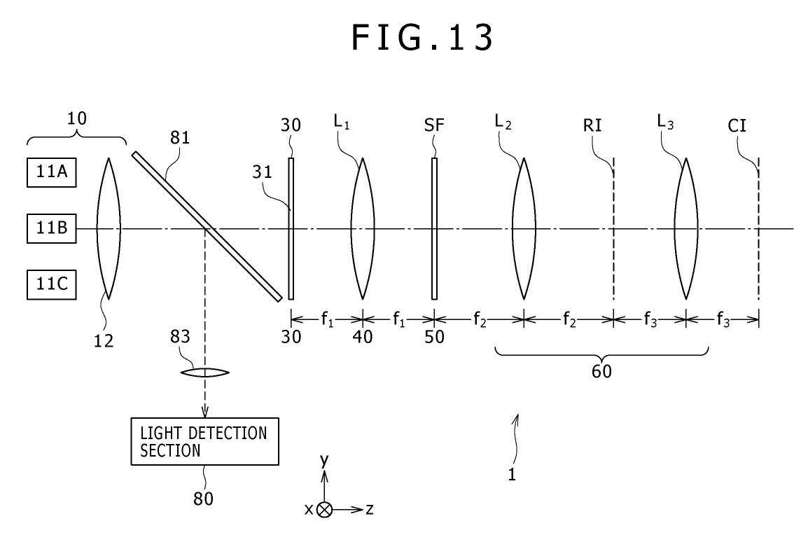

The working example 3 is a modification to the working example 1 and includes a light detection section 80 for measuring the intensity of light beams successively emitted from different light emitting positions of the light source 10. In particular, in the working example 3, the light detection section 80 is formed from a photodiode. As seen in FIG. 13 which shows the three-dimensional image display apparatus of the working example 3 along the yz plane, a partially reflecting mirror or partial reflector 81 is disposed between the light source 10 and the two-dimensional image forming apparatus 30, more particularly between the collimator lens 12 and the two-dimensional image forming apparatus 30. The partially reflecting mirror 81 extracts part of light to be introduced into the two-dimensional image forming apparatus 30 and directs the extracted light to the light detection section 80 through a lens 83.

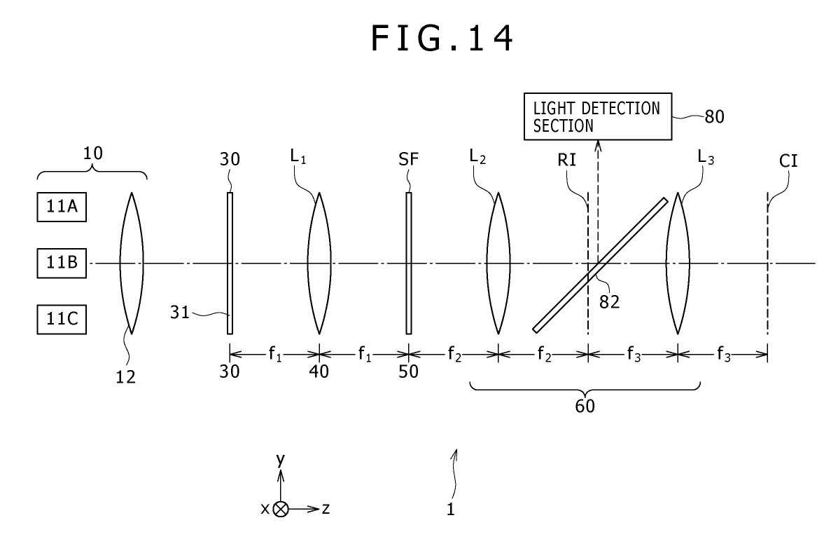

Or, a partially reflecting mirror 82 may be disposed rearwardly of the spatial filter SF or Fourier transform image selection section 50, more particularly, rearwardly of the second lens L₂ as seen in FIG. 14. Consequently, part of light emitted from the spatial filter SF or Fourier transform image selection section 50 is extracted and introduced to the light detection section 80 through a lens not shown.

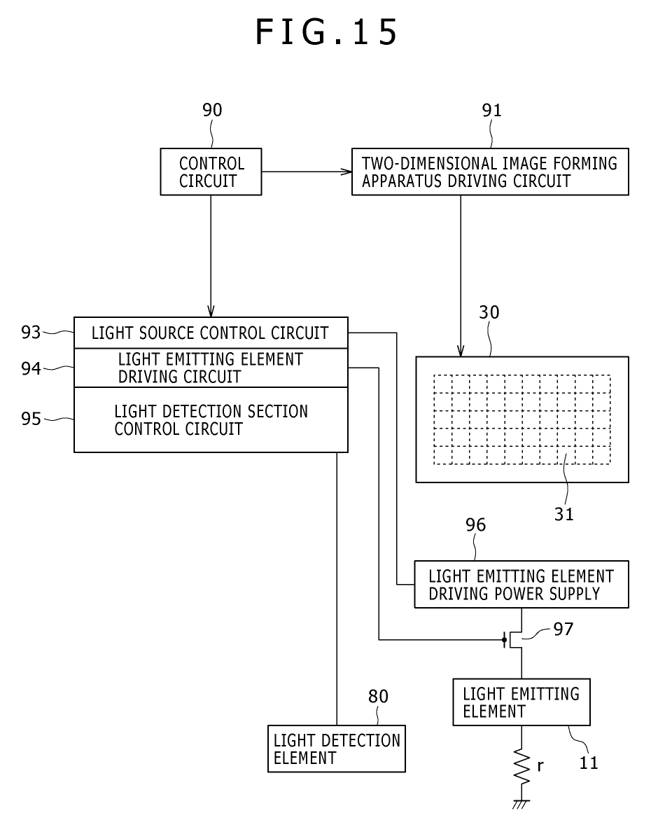

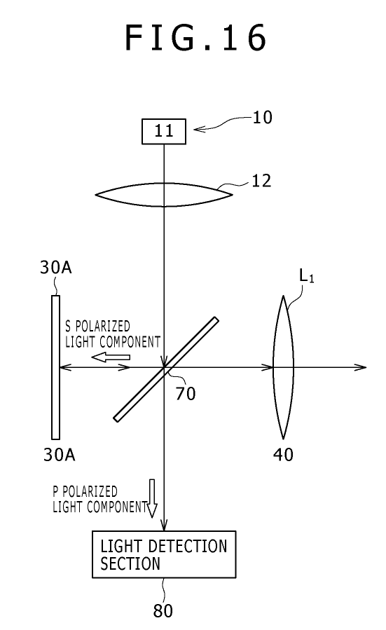

Further, the light emitting state of the light source 10 is controlled based on a result of measurement of the light intensity by the light detection section 80. In particular, as seen from FIG. 15, operation of the two-dimensional image forming apparatus 30, light source 10 and spatial filter SF or Fourier transform image selection section 50 is controlled by a control circuit 90. More particularly, the control circuit 90 includes a light source control circuit 93 for controlling the light emitting elements 11 between on and off in accordance with a pulse width modulation (PWM) control method, and a two-dimensional image forming apparatus driving circuit 91. The light source control circuit 93 includes a light emitting element driving circuit 94 and a light detection section control circuit 95. The control circuit 90 may be a known circuit.

The light emitting state of a light emitting element 11 is measured by the light detection section 80 formed from a photodiode, and an output of the light detection section 80 is inputted to the light detection section control circuit 95. The light detection section control circuit 95 converts the received output of the control circuit 90 into data or a signal representing, for example, a luminance and a chromaticity of the light emitting element 11. The data is sent to the light source control circuit 93, by which it is compared with reference data. Then, the light emitting state of the light emitting element 11 upon subsequently light emission is controlled based on a result of the comparison by the light emitting element driving circuit 94 under the control of the light source control circuit 93. In this manner, a feedback control mechanism is formed from the elements mentioned. Further, a resistor r for current detection is inserted in series to the light emitting element 11 on the downstream side of the light emitting element 11 such that current flowing therethrough is converted into a voltage. Then, operation of a light emitting element driving power supply 96 is controlled so that the voltage drop across the resistor r may have a predetermined value under the control of the light source control circuit 93.

Or, the operation state of the two-dimensional image forming apparatus 30 is controlled based on a result of measurement of the light intensity by the light detection section 80. In particular, the light emitting state of the light emitting element 11 is measured by the light detection section 80 formed from a photodiode, and an output of the light detection section 80 is inputted to the light detection section control circuit 95. The light detection section control circuit 95 converts the output of the light detection section 80 into data or a signal representative of, for example, a luminance and a chromaticity of the light emitting element 11. The data is sent to the light source control circuit 93, by which it is compared with reference data, and a result of the comparison is sent to the two-dimensional image forming apparatus driving circuit 91. Then, upon next light emission of the same light emitting element 11, the numerical aperture or transmission factor of the pixel 31 is controlled based on the result of the comparison. In this manner, a feedback mechanism is formed from the elements mention. It is to be noted that control of the light emitting state of the light source 10 and control of the operation state of the two-dimensional image forming apparatus 30 may be carried out together. Further, the operation state of the spatial filter SF or Fourier transform image selection section 50 is controlled based on the result of the measurement of the light intensity by the light detection section 80. The correction of the luminance can be carried out by controlling the numerical aperture or light transmission factor of the aperture 51 of the spatial filter SF or Fourier transform image selection section 50.

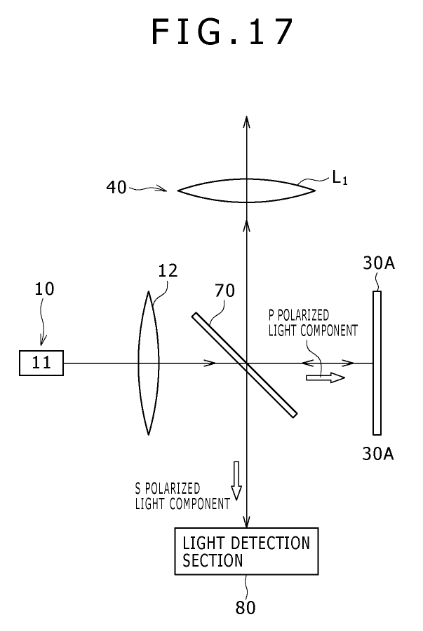

An example wherein the three-dimensional image display apparatus described above with reference to FIGS. 11 and 12 in the working example 2 is incorporated in the light detection section 80 is shown in FIGS. 16 and 17. More particularly, FIGS. 16 and 17 show a three-dimensional image display apparatus wherein the beam splitter 70 is disposed between the light source 10 and the two-dimensional image forming apparatus 30 such that part of light to be introduced from the light source 10 to the two-dimensional image forming apparatus 30 is extracted and introduced to the light detection section 80 through a lens not shown.

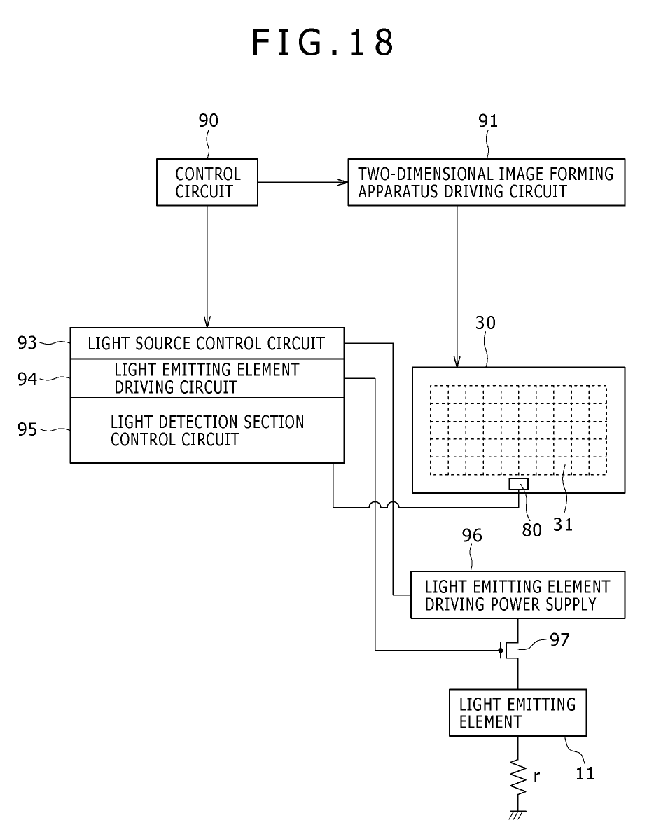

Meanwhile, an example wherein the light detection section 80 is attached to the two-dimensional image forming apparatus 30 is shown in FIG. 18. It is to be noted that the light detection section 80 may be disposed in the proximity of each of the light emitting elements 11 shown in FIG. 6. Or, the light detection section 80 may be incorporated in each of the light emitting elements 11 or may be disposed at a position at which it does not intercept a light beam to be introduced to the two-dimensional image forming apparatus 30 from the light source 10.

While the three-dimensional image display apparatus of the present invention is described above in connection with preferred working examples thereof, the present invention is not limited to the working examples. While, in the working examples, the collimator lens 12 is disposed between the light source 10 and the optical modulation section or two-dimensional image forming apparatus 30 or 30A, a microlens array wherein microlenses are arrayed in a two-dimensional matrix may be used instead.

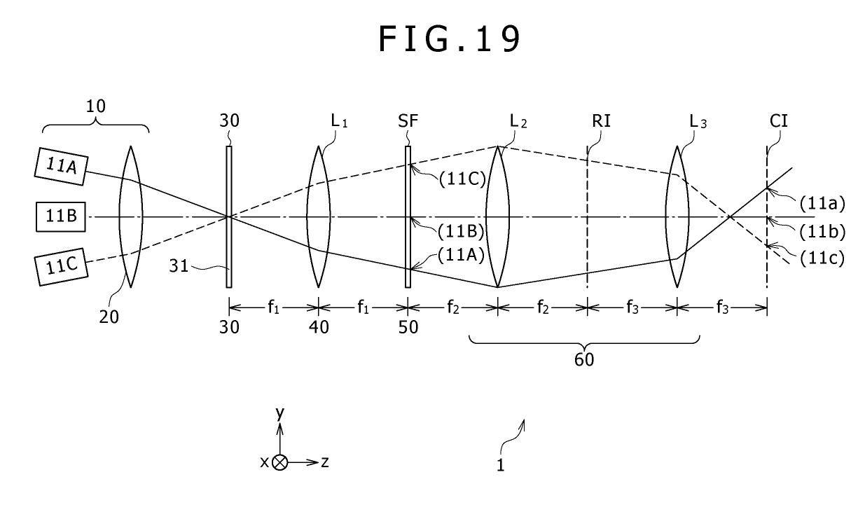

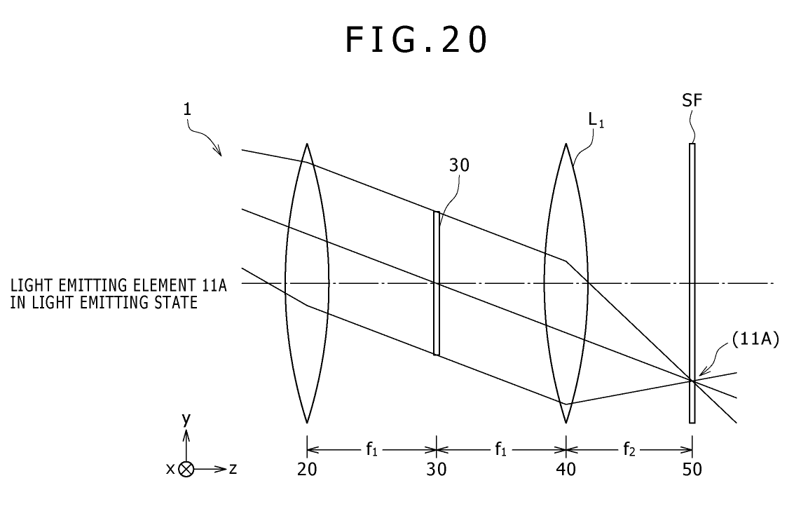

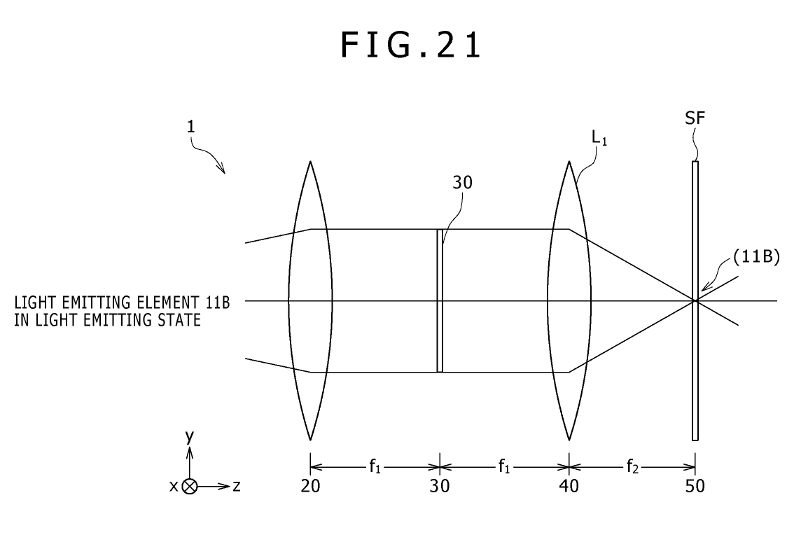

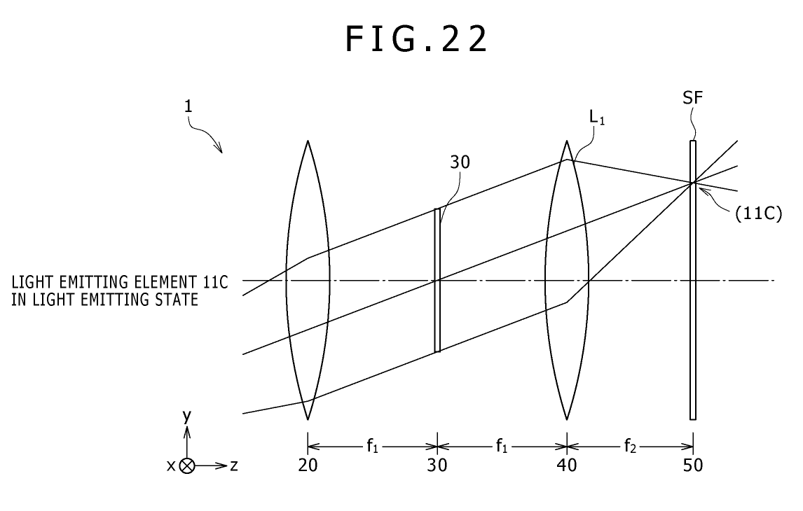

The light source 10 may include a plurality of light emitting elements 11 arrayed in a two-dimensional matrix such that light beams are emitted in different light emitting directions from each other from each of the light emitting elements 11. By the arrangement, the light detection section or two-dimensional image forming apparatus can be illuminated with illuminating light beams successively emitted from different light emitting positions of the light source and having different light emitting directions from each other. A configuration of a three-dimensional image display apparatus where the light source having such a configuration as described above is adopted in the three-dimensional image display apparatus of the working example 1 is shown in FIG. 19. It is to be noted that, in FIG. 19, a flux of light emitted from a light emitting element 11A which is a component of the light source 10 is indicated by a solid line, and another flux of light emitted from another light emitting element 11B is indicated by an alternate long and short dash line while a further flux of light emitted from a further light emitting element 11C is indicated by broken line. Further, the positions of images on the spatial filter SF formed from illuminating light beams emitted from the light emitting elements 11A, 11B and 11C are represented by reference characters (11A), (11B) and (11C), respectively. Meanwhile, the positions of images on the rear side focal plane of the third lens L₃ formed from illuminating light beams emitted from the light emitting elements 11A, 11B and 11C are represented by reference characters (11a), (11b) and (11c), respectively. Further, manners wherein fluxes of light emitted from the light emitting elements 11A, 11B and 11C of the light source 10 pass through the two-dimensional image forming apparatus 30, the first lens L₁ and spatial filter SF are schematically shown in FIGS. 20, 21 and 22, respectively, which show the optical modulation section or the two-dimensional image forming apparatus 30, Fourier transform image forming section 40 or first lens L₁, Fourier transform image selection section 50 or spatial filter SF and associated elements are shown in an enlarged scale. The position numbers of the light emitting elements 11A, 11B and 11C of the light source 10 are, for example, (5, 0), (0, 0) and (−5, 0), respectively. Here, when one of the light emitting elements 11A, 11B and 11C is in a light emitting state, all of the other light emitting elements are in a no-light emitting state. It is to be noted that, in FIG. 19, reference numeral 20 denotes an illuminating optical system formed from a lens for shaping the illuminating light.

Or else, the light source may be configured such that it includes light advancing direction changing means for changing the advancing direction of the light beams emitted from the light emitting element. In particular, for example, a polygon mirror is rotated around an axis of rotation thereof while the inclination angle of the axis of rotation is controlled. Or, the light advancing direction changing means may be formed from a convex mirror having a curved face, a concave mirror having a curved face, a convex mirror formed from a polygon or a concave mirror formed from a polygon such that the position or the like of the mirror is controlled to vary or change the light emitting position of an illuminating light beam when it emerges from the mirror.

Or, the spatial filter SF or Fourier transform image selection section 50 may be replaced by a scattering diffraction restriction member having a number of apertures corresponding to the number of the light emitting positions and positioned on the rear side focal plane of the first lens L₁. This scattering diffraction restriction member can be produced by forming apertures such as, for example, pinholes in a plate-like member which does not pass light therethrough. Here, the position of each of the apertures may be set to a position at which a desired Fourier transform image or diffraction light beam such as, for example, a Fourier transform image having the 0th diffraction order from among Fourier transform images or diffraction light beams obtained by the Fourier transform image selection section 50 or first lens is formed. Such positions of the apertures may correspond to the light emitting positions disposed discretely.

In the working examples 1 and 2, the optical modulation means or two-dimensional image forming apparatus 30 or 30A or the diffraction light production means is disposed on the front side focal plane of the lens which forms the Fourier transform image forming section 40, that is, the first lens L₁, and the Fourier transform image selection section 50 is disposed on the rear side focal plane of the lens. However, as occasion demands, although deterioration appears with a stereoscopic image obtained finally, if such deterioration is permitted, then the optical modulation means or two-dimensional image forming apparatus 30 or 30A or the diffraction light production means may be disposed at a position displaced from the front side focal plane of the lens of the Fourier transform image forming section 40, that is, the first lens L₁, or the spatial filter SF or Fourier transform image selection section 50 may be disposed at a position displaced from the rear side focal plane of the lens. Further, any of the first lens L₁, second lens L₂ and third lens L₃ is not limited to a convex lens, but an appropriate lens may be selected suitably.

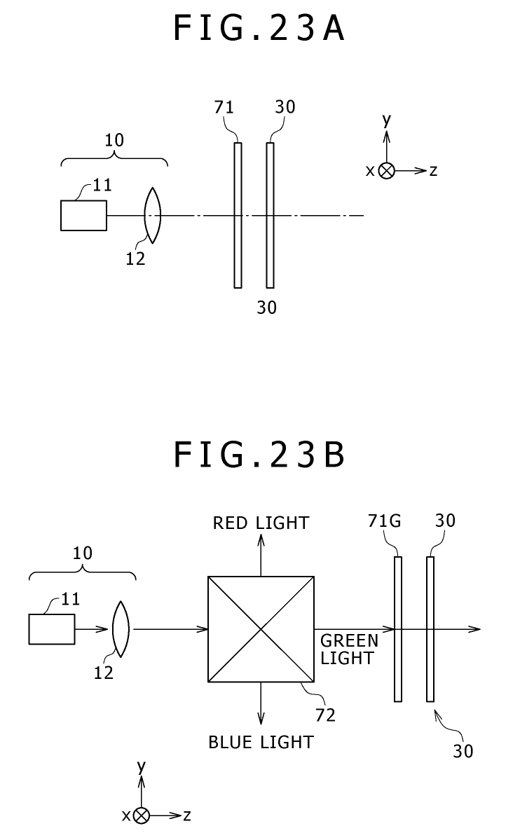

While it is assumed that, in the working examples 1 and 2, all light sources are single color light sources or light sources of a color proximate to a single color, the light source is not limited to that of this configuration. The light source 10 may emit light having a plurality of wavelength bands. However, in this instance, particularly where the three-dimensional image display apparatus of the working example 1 is taken as an example, preferably a narrow-band filter 71 for wavelength selection is disposed between the collimator lens 12 and the optical modulation means or two-dimensional image forming apparatus 30 as seen in FIG. 23A. With the narrow-band filter 71, it is possible to divide the wavelength band and select a desired divisional wavelength band to extract single color light.

Or, the light source 10 may have a wide frequency band. In this instance, however, preferably a dichroic prism 72 and a narrow-band filter 71G for wavelength selection are disposed between the collimator lens 12 and the optical modulation section or two-dimensional image forming apparatus 30 as seen in FIG. 23B. In particular, the dichroic prism 72 reflects, for example, a red light beam and a blue light beam in different directions while it passes a light beam including green light therethrough. The narrow-band filter 71G for separating and selecting green light is disposed on the emerging side of a light beam including green light of the dichroic prism 72.

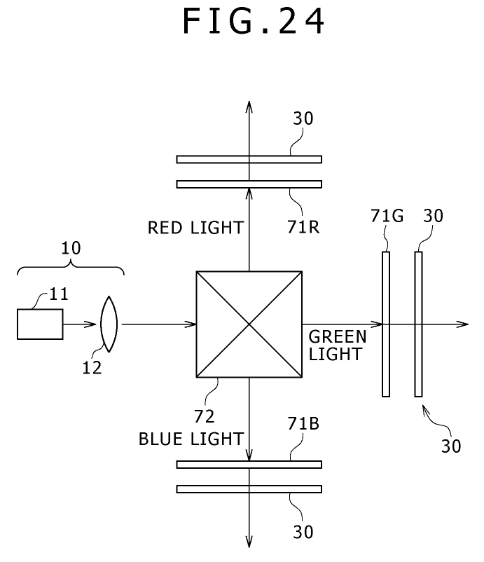

Or, it is possible to configure a light source for three three-dimensional image display apparatus for displaying three primary colors as shown in FIG. 24. Referring to FIG. 24, the light source shown includes a narrow-band filter 71G disposed on the emerging side of a light beam including green light of the dichroic prism 72 for separating and selecting the green light, a narrow-band filter 71R disposed on the emerging side of a light beam including red light for separating and selecting the red light and a narrow-band filter 71B disposed on the emerging side of a light beam including blue light for separating and selecting the blue light. If three three-dimensional image display apparatus of such a configuration described above are used or if a combination of a light source for emitting red light and a three-dimensional image display apparatus, another light source for emitting green light and another three-dimensional image display apparatus, and a further light source for emitting blue light and a further three-dimensional image display apparatus is used such that images from the three three-dimensional image display apparatus are synthesized, for example, using a light synthesizing prism, then color display can be implemented. It is to be noted that also a dichroic mirror may be used in place of the dichroic prim. Or else, it is possible also to form a light source from a red light emitting element, a green light emitting element and a blue light emitting element such that they are successively placed into a light emitting state to achieve color display. It is to be noted that modifications to such three-dimensional image display apparatus as described above can be applied also to the working example 2.

Further, the modifications to the three-dimensional image display apparatus described above may include the light detection means described hereinabove in connection with the working example 3. Further, the temperature of the light emitting element may be monitored by means of a temperature sensor such that a result of the monitoring is fed back to the light source control circuit 93 so that luminance compensation or correction or temperature control of the light emitting elements is carried out. In particular, for example, a Peltier element may be attached to the light emitting elements to carry out temperature control of the light emitting elements.

While preferred embodiments of the present invention have been described using specific terms, such description is for illustrative purpose only, and it is to be understood that changes and variations may be made without departing from the spirit or scope of the following claims.

What is claimed is:

1. A three-dimensional image display apparatus, comprising:
a light source configured to emit light from a plurality of light emitting positions disposed discretely;
optical modulation means for including a plurality of pixels and configured such that a plurality of light beams successively emitted from the different light emitting positions of said light source and having different incoming directions from each other are modulated individually by said pixels to generate two-dimensional images and spatial frequencies of the generated two-dimensional images are individually emitted along diffraction angles corresponding to a plurality of diffraction orders generated from said pixels; and
Fourier transform image forming means for Fourier transforming the spatial frequencies of the two-dimensional images emitted from said optical modulation means to produce a number of Fourier transform images corresponding to the plural number of diffraction orders to form the Fourier transform images.

2. The three-dimensional image display apparatus according to claim 1, further comprising:
conjugate image forming means for forming a conjugate image of any of the Fourier transform images formed by said Fourier transform image forming means.

3. The three-dimensional image display apparatus according to claim 1, wherein said light source includes a plurality of light emitting elements arrayed in a two-dimensional matrix.

4. The three-dimensional image display apparatus according to claim 1, further comprising a lens interposed between said light source and said optical modulation means such that said light source is positioned on a front side focal plane of said lens.

5. The three-dimensional image display apparatus according to claim 1, wherein said light source includes a light emitting element and light beam advancing direction changing means for changing the incoming direction of light emitted from said light emitting element and directed to be introduced to said optical modulation means.

6. The three-dimensional image display apparatus according to claim 1, wherein said Fourier transform image forming means includes a lens having a front side focal plane on which said optical modulation means is disposed.

7. The three-dimensional image display apparatus according to claim 1, further comprising:
Fourier transform image selection means disposed at a position at which the Fourier transform images are formed and for selecting, from among the number of Fourier transform images corresponding to the plural number of diffraction orders generated by said Fourier transform image forming means, a Fourier transform image which corresponds to a desired one of the diffraction orders.

8. The three-dimensional image display apparatus according to claim 7, wherein said Fourier transform image selection means has a number of apertures corresponding to the number of the light emitting positions and makes a desired one of said apertures into an open state in synchronism with a generation timing of a two-dimensional image by said optical modulation means to select one of the Fourier transform images which corresponds to the desired diffraction order.

9. The three-dimensional image display apparatus according to claim 1, further comprising inverse Fourier transform means for inversing Fourier transform any of the Fourier transform images formed by said Fourier transform image forming means to form a real image of the two-dimensional image formed by said optical modulation means.

10. The three-dimensional image display apparatus according to claim 1, wherein said optical modulation means includes a two-dimensional spatial optical modulator having a plurality of pixels arrayed two-dimensionally, each of said pixels having an aperture.

11. The three-dimensional image display apparatus according to claim 1, further comprising light detection means for measuring the light intensity of the light beams successively emitted from the different light emitting positions of said light source.

12. The three-dimensional image display apparatus according to claim 11, wherein the light emitting state of said light source is controlled based on a result of the measurement of the light intensity by said light detection means.

13. The three-dimensional image display apparatus according to claim 11, wherein an operation state of said optical modulation means is controlled based on a result of the measurement of the light intensity by said light detection means.

14. A three-dimensional image display apparatus, comprising:
a light source configured to emit light from a plurality of light emitting positions disposed discretely;
a two-dimensional image forming apparatus having a plurality of apertures arrayed in a two-dimensional matrix along an X direction and a Y direction and configured to control, for each of said apertures, passage or reflection of each of light beams successively emitted from the different light emitting positions of said light source and having different incoming directions from each other to produce two-dimensional images and generate, for each of said apertures, a plurality of diffraction light beams of different diffraction orders based on the two-dimensional images;
a first lens having a front side focal plane on which said two-dimensional image forming apparatus is disposed;
a second lens having a front side focal plane on which a rear side focal plane of said first lens is positioned; and
a third lens having a front side focal plane on which a rear side focal plane of said second lens is positioned.

15. The three-dimensional image display apparatus according to claim 14, wherein said light source includes a plurality of light emitting elements arrayed in a two-dimensional matrix.

16. The three-dimensional image display apparatus according to claim 14, further comprising a lens interposed between said light source and said two-dimensional image forming apparatus such that said light source is positioned on a front side focal plane of said lens.

17. The three-dimensional image display apparatus according to claim 14, wherein said light source includes a light emitting element and light beam advancing direction changing means for changing the incoming direction of light emitted from said light emitting element and directed to be introduced to said two-dimensional image forming apparatus.

18. The three-dimensional image display apparatus according to claim 14, further comprising:
a spatial filter having a number of apertures corresponding to the number of the light emitting positions and capable of being controlled to open and close, said spatial filter being positioned on the rear side focal plane of said first lens.

19. The three-dimensional image display apparatus according to claim 18, wherein said spatial filter makes a desired one of said apertures into an open state in synchronism with a generation timing of a two-dimensional image by said two-dimensional image forming apparatus.

20. The three-dimensional image display apparatus according to claim 14, further comprising:
a scattering diffraction restriction member having a number of apertures corresponding to the number of the light emitting positions and positioned on the rear side focal plane of said first lens.

21. The three-dimensional image display apparatus according to claim 14, further comprising light detection means for measuring the light intensity of the light beams successively emitted from the different light emitting positions of said light source.

22. The three-dimensional image display apparatus according to claim 21, wherein the light emitting state of said light source is controlled based on a result of the measurement of the light intensity by said light detection means.

23. The three-dimensional image display apparatus according to claim 21, wherein an operation state of said two-dimensional image forming apparatus is controlled based on a result of the measurement of the light intensity by said light detection means.
